(19) United States
(12) Patent Application Publication
(10) Pub. No.: US 2023/0120092 A1
(43) Pub. Date: Apr. 20, 2023

(54) INFORMATION PROCESSING DEVICE AND INFORMATION PROCESSING METHOD

(71) Applicant: SONY GROUP CORPORATION, TOKYO (JP)

(72) Inventors: DAITA KOBAYASHI, TOKYO (JP); HAJIME WAKABAYASHI, TOKYO (JP); HIROTAKE ICHIKAWA, TOKYO (JP); ATSUSHI ISHIHARA, TOKYO (JP); HIDENORI AOKI, TOKYO (JP); YOSHINORI OGAKI, TOKYO (JP); YU NAKADA, TOKYO (JP); RYOSUKE MURATA, TOKYO (JP); TOMOHIKO GOTOH, TOKYO (JP); SHUNITSU KOHARA, TOKYO (JP); HARUKA FUJISAWA, TOKYO (JP); MAKOTO DANIEL TOKUNAGA, TOKYO (JP)

(21) Appl. No.: 17/905,185

(22) PCT Filed: Feb. 4, 2021
(86) PCT No.: PCT/JP2021/004147

§ 371 Date: Aug. 29, 2022

(30) Foreign Application Priority Data
Mar. 6, 2020 (JP) 2020-039237

(51) Int. Cl. G06T 7/70; G06T 7/579; G06V 10/74; G06F 3/14; G06F 3/16; G01C 19/00

(52) U.S. Cl. CPC G06T 7/70; G06T 7/579; G06V 10/761; G06F 3/14; G06F 3/16; G01C 19/00; G06T 2207/30241

(57) ABSTRACT

An information processing device includes an output control unit (173) that controls output on a presentation device so as to present content associated with an absolute position in a real space, to a first user, a determination unit (171) that determines a self-position in the real space, a transmission unit (172) that transmits a signal requesting rescue to a device positioned in the real space, when reliability of determination by the determination unit (171) is reduced, an acquisition unit (174) that acquires information about the self-position estimated from an image including the first user captured by the device according to the signal; and a correction unit (175) that corrects the self-position based on the information about the self-position acquired by the acquisition unit (174).

### FIELD

The present disclosure relates to an information processing device and an information processing method.

### BACKGROUND

Conventionally, there is known a technology to provide content associated with an absolute position in a real space for a head-mounted display or the like worn by a user, for example, a technology such as augmented reality (AR) or mixed reality (MR) is known. Use of the technology makes it possible to provide, for example, virtual objects of various forms, such as text, icon, or animation, so as to be superimposed on the field of view of the user through a camera.

Furthermore, in recent years, provision of applications such as immersive location-based entertainment (LBE) games using this technology has also started.

Incidentally, in a case where such content as described above is provided to the user, it is necessary to always grasp the environment around the user including an obstacle and the like and the position of the user. As a method for grasping the environment and position of the user, simultaneous localization and mapping (SLAM) or the like is known that simultaneously performs self-localization of the user and environmental map creation.

However, even if such a method is used, the self-localization of the user may fail due to, for example, a small number of feature points in the real space around the user. Such a state is referred to as a lost state. Therefore, a technology for returning from the lost state has also been proposed.

### CITATION LIST

### Patent Literature

Patent Literature 1: WO 2011/101945 A
Patent Literature 2: JP 2016-212039 A

### SUMMARY

### Technical Problem

However, the above-described conventional technique has a problem that a processing load and power consumption increase.

Therefore, the present disclosure proposes an information processing device and an information processing method that are configured to implement returning of a self-position from a lost state in content associated with an absolute position in a real space, with a low load.

### Solution to Problem

In order to solve the above problems, one aspect of an information processing device according to the present disclosure includes an output control unit that controls output on a presentation device so as to present content associated with an absolute position in a real space, to a first user; a determination unit that determines a self-position in the real space; a transmission unit that transmits a signal requesting rescue to a device positioned in the real space, when reliability of determination by the determination unit is reduced; an acquisition unit that acquires information about the self-position estimated from an image including the first user captured by the device according to the signal; and a correction unit that corrects the self-position based on the information about the self-position acquired by the acquisition unit.

### BRIEF DESCRIPTION OF DRAWINGS

FIG. 1 is a diagram illustrating an example of a schematic configuration of an information processing system according to a first embodiment of the present disclosure.

FIG. 2 is a diagram illustrating an example of a schematic configuration of a terminal device according to the first embodiment of the present disclosure.

FIG. 3 is a diagram (No. 1) illustrating an example of a lost state of a self-position.

FIG. 4 is a diagram (No. 2) illustrating an example of the lost state of the self-position.

FIG. 5 is a state transition diagram related to self-localization.

FIG. 6 is a diagram illustrating an overview of an information processing method according to the first embodiment of the present disclosure.

FIG. 7 is a block diagram illustrating a configuration example of a server device according to the first embodiment of the present disclosure.

FIG. 8 is a block diagram illustrating a configuration example of the terminal device according to the first embodiment of the present disclosure.

FIG. 9 is a block diagram illustrating a configuration example of a sensor unit according to the first embodiment of the present disclosure.

FIG. 10 is a table illustrating examples of a wait action instruction.

FIG. 11 is a table illustrating examples of a help/support action instruction.

FIG. 12 is a table illustrating examples of an individual identification method.

FIG. 13 is a table illustrating examples of a posture estimation method.

FIG. 14 is a sequence diagram of a process performed by the information processing system according to the embodiment.

FIG. 15 is a flowchart (No. 1) illustrating a procedure of a process for a user A.

FIG. 16 is a flowchart (No. 2) illustrating the procedure of the process for the user A.

FIG. 17 is a flowchart illustrating a procedure of a process in the server device.

FIG. 18 is a flowchart illustrating a procedure of a process for a user B.

FIG. 19 is an explanatory diagram of a process according to a first modification.

FIG. 20 is an explanatory diagram of a process according to a second modification.

FIG. 21 is a diagram illustrating an overview of an information processing method according to a second embodiment of the present disclosure.

FIG. 22 is a block diagram illustrating a configuration example of a terminal device according to the second embodiment of the present disclosure.

FIG. 23 is a block diagram illustrating a configuration example of an estimation unit according to the second embodiment of the present disclosure.

FIG. 24 is a table of transmission information transmitted by each user.

FIG. 25 is a block diagram illustrating a configuration example of a server device according to the second embodiment of the present disclosure.

FIG. 26 is a flowchart illustrating a procedure of a trajectory comparison process.

FIG. 27 is a hardware configuration diagram illustrating an example of a computer implementing the functions of the terminal device.

### DESCRIPTION OF EMBODIMENTS

The embodiments of the present disclosure will be described in detail below with reference to the drawings. Note that in the following embodiments, the same portions are denoted by the same reference numerals and symbols, and a repetitive description thereof will be omitted.

Furthermore, in the present description and the drawings, a plurality of component elements having substantially the same functional configurations may be distinguished by giving the same reference numerals that are followed by different hyphenated numerals, in some cases. For example, a plurality of configurations having substantially the same functional configuration is distinguished as necessary, such as a terminal device 100-1 and a terminal device 100-2. However, in a case where there is no need to particularly distinguish the plurality of component elements having substantially the same functional configuration, the component elements are denoted by only the same reference numeral. For example, when it is not necessary to particularly distinguish the terminal device 100-1 and the terminal device 100-2 from each other, the terminal devices are simply referred to as terminal devices 100.

Furthermore, the present disclosure will be described in the order of items shown below.

1. First Embodiment

1-1. Overview

1-1-1. Example of schematic configuration of information processing system

1-1-2. Example of schematic configuration of terminal device

1-1-3. Example of lost state of self-position

1-1-4. Overview of present embodiment

1-2. Configuration of information processing system

1-2-1. Configuration of server device

1-2-2. Configuration of terminal device

1-3. Procedure of process performed by information processing system

1-3-1. Overall processing sequence

1-3-2. Procedure of process for user A

1-3-3. Procedure of process in server device

1-3-4. Procedure of process for user B

1-4. Modifications

1-4-1. First Modification

1-4-2. Second Modification

1-4-3. Other Modifications

2. Second Embodiment

2-1. Overview

2-2. Configuration of information processing system

2-2-1. Configuration of terminal device

2-2-2. Configuration of server device

2-3. Procedure of trajectory comparison process

2-4. Modifications

3. Other modifications

4. Hardware configuration

5. Conclusion

### 1. First Embodiment

### 1-1. Overview

### 1-1-1. Example of Schematic Configuration of Information Processing System

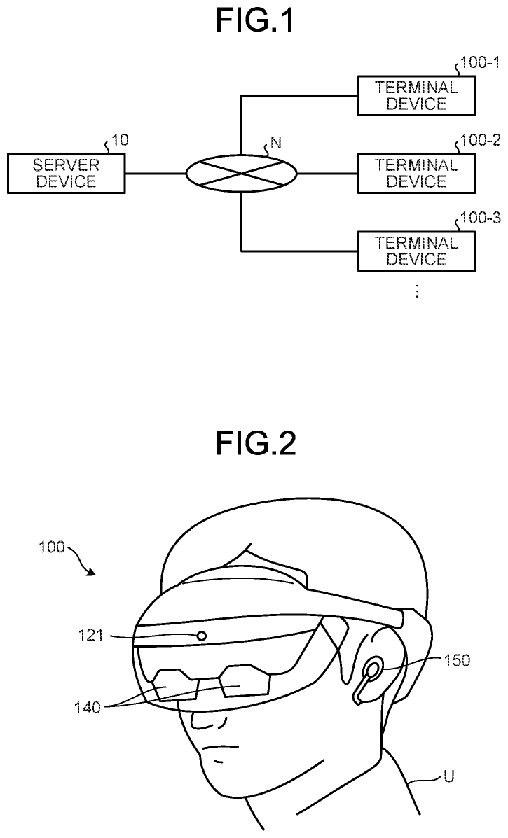

FIG. 1 is a diagram illustrating an example of a schematic configuration of an information processing system 1 according to a first embodiment of the present disclosure. The information processing system 1 according to the first embodiment includes a server device 10 and one or more terminal devices 100. The server device 10 provides common content associated with a real space. For example, the server device 10 controls the progress of an LBE game. The server device 10 is connected to a communication network N and communicates data with each of one or more terminal devices 100 via the communication network N.

Each terminal device 100 is worn by a user who uses the content provided by the server device 10, for example, a player of the LBE game or the like. The terminal device 100 is connected to the communication network N and communicates data with the server device 10 via the communication network N.

### 1-1-2. Example of Schematic Configuration of Terminal Device

FIG. 2 illustrates a state in which the user U wears the terminal device 100. FIG. 2 is a diagram illustrating an example of a schematic configuration of the terminal device 100 according to the first embodiment of the present disclosure. As illustrated in FIG. 2, the terminal device 100 is implemented by, for example, a wearable terminal with a headband (head mounted display (HMD)) that is worn on the head of the user U.

The terminal device 100 includes a camera 121, a display unit 140, and a speaker 150. The display unit 140 and the speaker 150 correspond to examples of a “presentation device”. The camera 121 is provided, for example, at the center portion, and captures an angle of view corresponding to the field of view of the user U when the terminal device 100 is worn.

The display unit 140 is provided at a portion located in front of the eyes of the user U when the terminal device 100 is worn, and presents images corresponding to the right and left eyes. Note that the display unit 140 may have a so-called optical see-through display with optical transparency, or may have an occlusive display.

For example, in a case where the LBE game is AR content using an optical see-through system to check a surrounding environment through a display of the display unit 140, a transparent HMD using the optical see-through display can be used. Furthermore, for example, in a case where the LBE game is AR content using a video see-through system to check a video image obtained by capturing the surrounding environment, on a display, an HMD using the occlusive display can be used.

Note that, in the first embodiment described below, an example in which the HMD is used as the terminal device 100 will be described, but in a case where the LBE game is the AR content using the video see-through system, a mobile device such as a smartphone or tablet having a display may be used as the terminal device 100.

The terminal device 100 is configured to display a virtual object on the display unit 140 to present the virtual object within the field of view of the user U. In other words, the terminal device 100 is configured to control the virtual object to be displayed on the display unit 140 that has transparency so that the virtual object seems to be superimposed on the real space, and function as a so-called AR terminal implementing augmented reality. Note that the HMD, which is an example of the terminal device 100, is not limited to an HMD that presents an image to both eyes, and may be an HMD that presents an image to only one eye.

Furthermore, the shape of the terminal device 100 is not limited to the example illustrated in FIG. 2. The terminal device 100 may be an HMD of glasses type, or an HMD of helmet type that has a visor portion corresponding to the display unit 140.

The speaker 150 is implemented as headphones worn on the ears of the user U, and for example, dual listening headphones can be used. The speaker 150 is configured to, for example, both of output of sound of the LBE game and conversation with another user.

### 1-1-3. Example of Lost State of Self-Position

Incidentally, many of AR terminals currently available use SLAM for self-localization. SLAM processing is implemented by combining two self-localization methods of visual inertial odometry (VIO) and Relocalize.

VIO is a method of obtaining a relative position from a certain point by integration by using a camera image of the camera 121 and an inertial measurement unit (IMU: corresponding to at least a gyro sensor 123 and an acceleration sensor 124 which are described later).

The Relocalize is a method of comparing a camera image with a set of key frames created in advance to identify an absolute position with respect to the real space. Each of the key frames is information such as an image of the real space, depth information, and a feature point position that are used for identifying a self-position, and the Relocalize corrects the self-position upon recognition of the key frame (hit a map). Note that a database in which a plurality of key frames and metadata associated with the key frames are collected may be referred to as a map DB.

Roughly speaking, in SLAM, fine movements in a short period are estimated by VIO, and sometimes coordinates are matched between a world coordinate system that is a coordinate system of the real space and a local coordinate system that is a coordinate system of the AR terminal by Relocalize, and accumulated errors are eliminated by VIO.

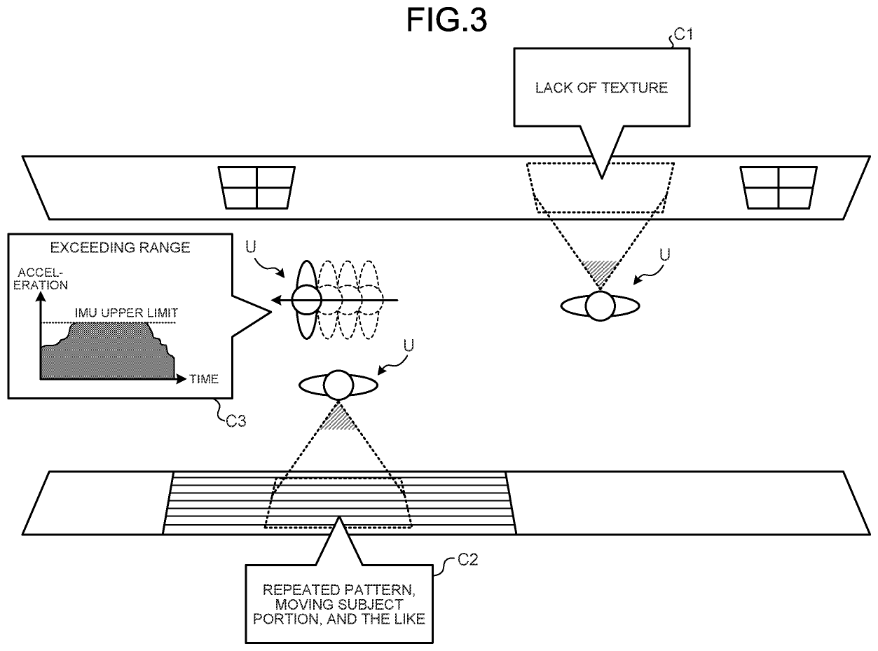

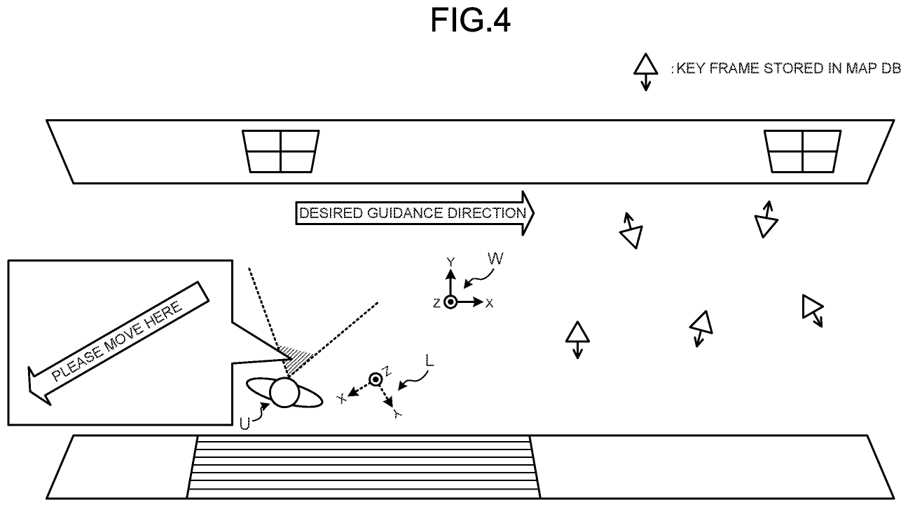

Such SLAM may fail in the self-localization in some cases. FIG. 3 is a diagram (No. 1) illustrating an example of a lost state of the self-position. Furthermore, FIG. 4 is a diagram (No. 2) illustrating an example of the lost state of the self-position.

As illustrated in FIG. 3, first, the cause of the failure includes lack of texture that is seen on a plain wall or the like (see case C1 in the drawing). VIO and Relocalize which are described above cannot perform correct estimation without sufficient texture, that is, without sufficient image feature points.

Next, the cause of the failure includes a repeated pattern, a moving subject portion, or the like (see case C2 in the drawing). For example, the repeated pattern such as a blind or a lattice, or the area of the moving subject is likely to be erroneously estimated in the first place, and therefore, even if the repeated pattern or the area is detected, the repeated pattern or the area is rejected as an estimation target region. Therefore, available feature points are insufficient, and the self-localization may fail.

Next, the cause of the failure includes the IMU that exceeds a range (see case C3 in the drawing). For example, when strong vibration is applied to the AR terminal, output from the IMU exceeds an upper limit, and the position obtained by integration is incorrectly obtained. Therefore, the self-localization may fail.

When the self-localization fails due to these causes, the virtual object is not localized at a correct position or makes an indefinite movement, significantly reducing the experience value from the AR content, but it can be said that this is an inevitable problem as long as the image information is used.

Note that in a case where the self-localization fails and the coordinates described above do not match each other, a correct direction cannot be presented on the display unit 140 even if it is desired to guide the user U to a direction in which the key frames are positioned, as illustrated in FIG. 4. This is because the world coordinate system W and the local coordinate system L do not match each other.

Therefore, in such a case, currently, for example, the user U needs to be manually guided to an area where many key frames are positioned by an assistant person, and the map needs to be hit. Therefore, it is important how to make a fast return from such a state where the self-localization fails with a low load.

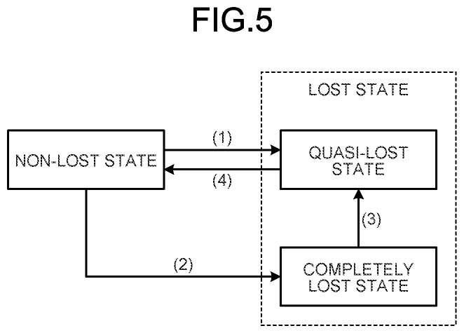

Here, states of the failure in self-localization will be defined. FIG. 5 is a state transition diagram related to the self-localization. As illustrated in FIG. 5, in the first embodiment of the present disclosure, a state of self-localization is divided into a “non-lost state”, a “quasi-lost state”, and a “completely lost state”. The “quasi-lost state” and the “completely lost state” are collectively referred to as the “lost state”.

The “non-lost state” is a state in which the world coordinate system W and the local coordinate system L match each other, and in this state, for example, the virtual object appears to be localized at a correct position.

The “quasi-lost state” is a state in which VIO works correctly but the coordinates are not matched well by Relocalize, and in this state, for example, the virtual object appears to be localized at a wrong position or in a wrong orientation.

The “completely lost state” is a state in which SLAM fails due to inconsistency between the position estimation based on the camera image and the position estimation by IMU, and in this state, for example, the virtual object appears to fly away or move around.

The “non-lost state” may transition to the “quasi-lost state” due to (1) hitting no map for a long time, viewing the repeated pattern, or the like. The “non-lost state” may transition to the “completely lost state” due to (2) the lack of texture, exceeding the range, or the like.

The “completely lost state” may transition to the “quasi-lost state” due to (3) resetting SLAM. The “quasi-lost state” may transition to the “completely lost state” by (4) viewing the key frames stored in the map DB and hitting the map.

Note that upon activation, the state starts from the “quasi-lost state”. At this time, for example, it is possible to determine that the reliability of SLAM is low.

### 1-1-4. Overview of Present Embodiment

On the basis of the premise as described above, in an information processing method according to the first embodiment of the present disclosure, output on a presentation device is controlled to present content associated with an absolute position in a real space to a first user, a self-position in the real space is determined, a signal requesting rescue is transmitted to a device positioned in the real space when reliability of the determination is reduced, information about the self-position is acquired that is estimated from an image including the first user, captured by the device according to the signal, and the self-position is corrected on the basis of the acquired information about the self-position. Note that the “rescue” mentioned here means support for restoration of the reliability. Therefore, a “rescue signal” appearing below may be referred to as a request signal requesting the support.

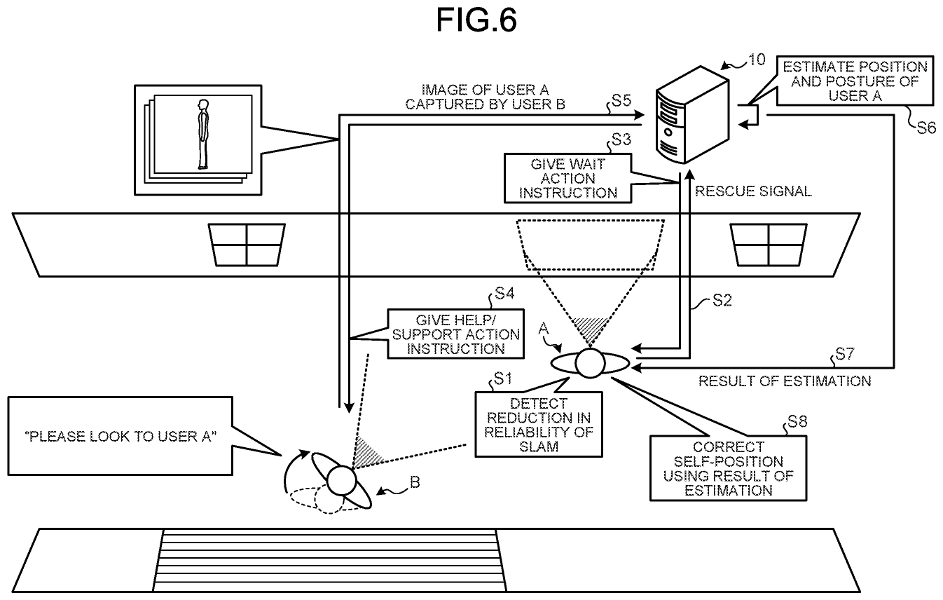

FIG. 6 is a diagram illustrating an overview of the information processing method according to the first embodiment of the present disclosure. Note that, in the following description, a user who is in the “quasi-lost state” or “completely lost state” and is a person who needs help is referred to as a “user A”. Furthermore, a user who is in the “non-lost state” and is a person who gives help/support for the user A is referred to as a “user B”. Note that, in the following, the user A or the user B may represent the terminal device 100 worn by each user.

Specifically, in the information processing method according to the first embodiment, it is assumed that each user always transmits the self-position to the server device 10 and the positions of all the users can be known by the server device 10. In addition, each user can determine the reliability of SLAM of him/her-self. The reliability of SLAM is reduced, for example, when a camera image has a small number of feature points thereon or no map is hit for a certain period of time.

Here, as illustrated in FIG. 6, it is assumed that the user A has detected, for example, a reduction in the reliability of SLAM indicating that the reliability of SLAM is equal to or less than a predetermined value (Step S1). Then, the user A determines that he/she is in the “quasi-lost state”, and transmits the rescue signal to the server device 10 (Step S2).

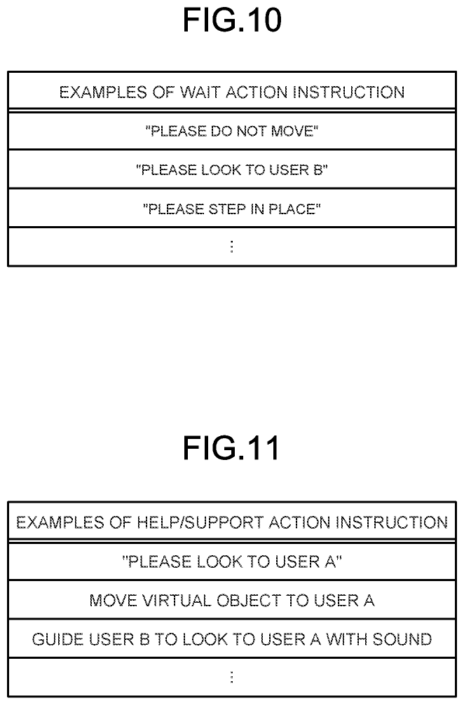

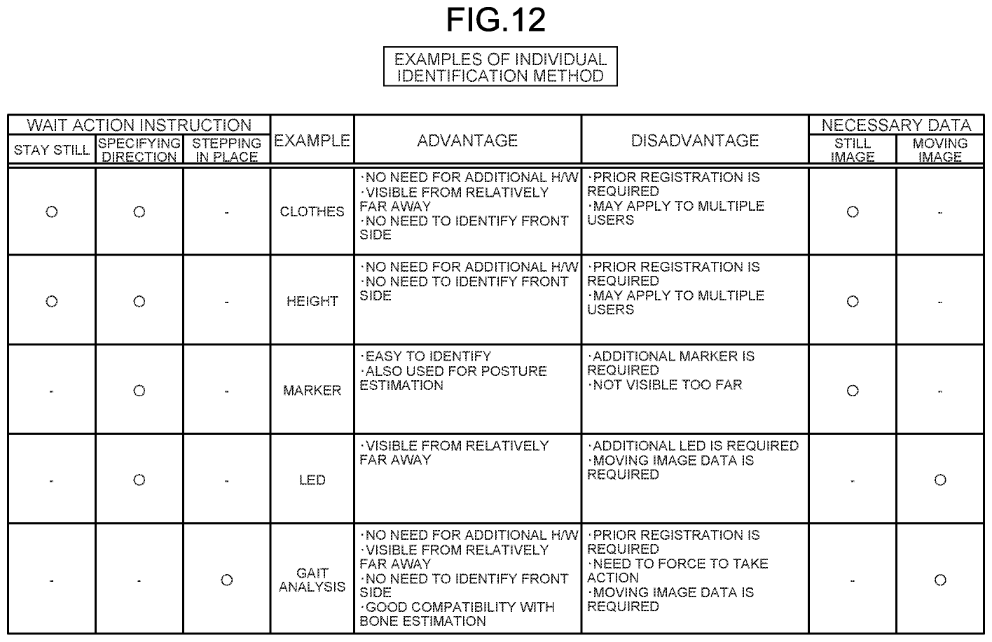

Upon receiving the rescue signal, the server device 10 instructs the user A to take wait action (Step S3). For example, the server device 10 causes a display unit 140 of the user A to display an instruction content such as “Please do not move”. The instruction content changes according to an individual identification method for the user A which is described later. The examples of the wait action instruction will be described later with reference to FIG. 10, and examples of the individual identification method will be described later with reference to FIG. 12.

Furthermore, when receiving the rescue signal, the server device 10 instructs the user B to take help/support action (Step S4). For example, the server device 10 causes a display unit 140 of the user B to display an instruction content such as “please look toward the user A”, as illustrated in the drawing. The examples of the help/support action instruction will be described later with reference to FIG. 11.

When a specific person enters the angle of view for a certain period of time, the camera 121 of the user B automatically captures an image including the person and transmits the image to the server device 10. In other words, when the user B looks to the user A in response to the help/support action instruction, the user B captures an image of the user A and transmits the image to the server device 10 (Step S5).

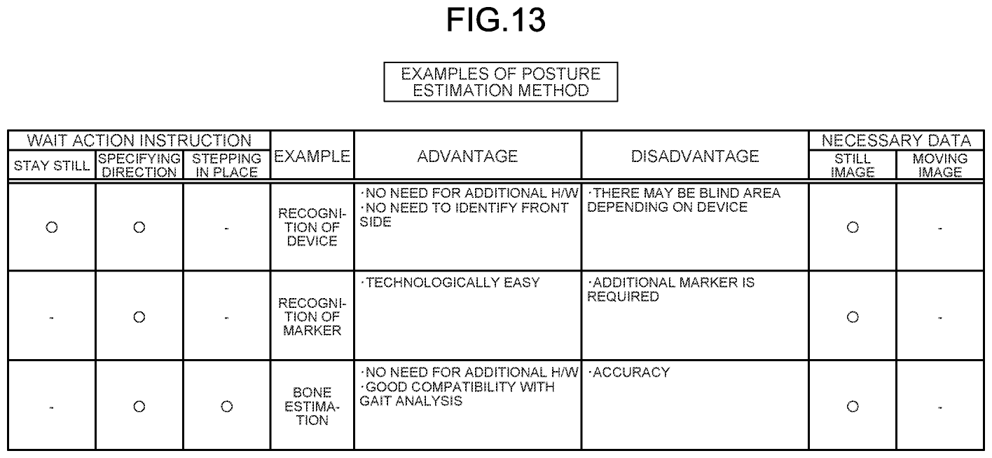

Note that the image may be either a still image or a moving image. Whether the image is the still image or the moving image depends on the individual identification method or a posture estimation method for the user A which is described later. The examples of the individual identification method will be described later with reference to FIG. 12, and examples of the posture estimation method will be described later with reference to FIG. 13.

When the transmission of the image is finished, the process of rescue support finishes, and the user B returns to a normal state. The server device 10 that receives the image from the user B estimates the position and posture of the user A on the basis of the image (Step S6).

At this time, the server device 10 identifies the user A first, on the basis of the received image. A method for identification is selected according to the content of the wait action instruction described above. Then, after identifying the user A, the server device 10 estimates the position and posture of the user A viewed from the user B, on the basis of the same image. A method for estimation is also selected according to the content of the wait action instruction.

Then, the server device 10 estimates the position and posture of the user A in the world coordinate system W on the basis of the estimated position and posture of the user A viewed from the user B and the position and posture of the user B in the “non-lost state” in the world coordinate system W.

Then, the server device 10 transmits results of the estimation to the user A (Step S7). Upon receiving the results of the estimation, the user A corrects the self-position by using the results of the estimation (Step S8). Note that, in the correction, in a case where the user A is in the “completely lost state”, the user A returns its own state at least to the “quasi-lost state”. It is possible to return to the “quasi-lost state” by resetting SLAM.

The user A in the “quasi-lost state” reflects the results of the estimation from the server device 10 in the self-position, and thus, the world coordinate system W roughly matches the local coordinate system L. The transition to this state makes it possible to almost correctly display the area where many key frames are positioned and a direction on the display unit 140 of the user A, guiding the user A to the area where the map is likely to be hit.

Then, when the map is hit as a result of the guiding, the user A returns to the “non-lost state”, the virtual object is displayed on the display unit 140, and the user A returns to the normal state. Note that when no map is hit for the certain period of time, the rescue signal is preferably transmitted to the server device 10 again (Step S2).

As described above, with the information processing method according to the first embodiment, the rescue signal is output only if necessary, that is, when the user A is in the “quasi-lost state” or the “completely lost state”, and the user B as the person who gives help/support only needs to transmit several images to the server device 10 in response to the rescue signal. Therefore, for example, it is not necessary for the terminal devices 100 to mutually estimate the positions and postures, and the processing load is prevented from being high as well. In other words, the information processing method according to the first embodiment makes it possible to implement returning of the self-position from the lost state in the content associated with the absolute position in the real space with a low load.

Furthermore, in the information processing method according to the first embodiment, the user B only needs to have a glance at the user A as the person who gives help/support, and thus, it is possible to return the user A from the lost state without reducing the experience value of the user B. A configuration example of the information processing system 1 to which the information processing method according to the first embodiment described above is applied will be described below more specifically.

### 1-2. Configuration of Information Processing System

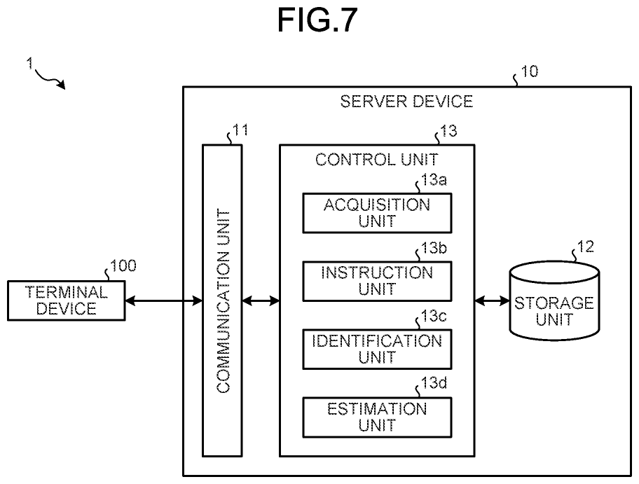

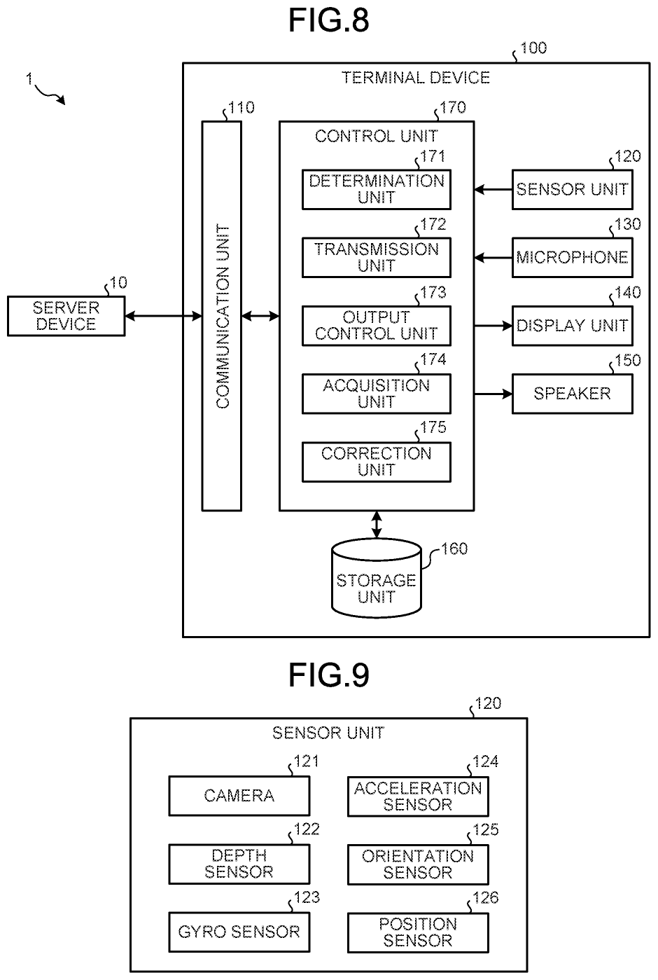

FIG. 7 is a block diagram illustrating a configuration example of the server device 10 according to the first embodiment of the present disclosure. FIG. 8 is a block diagram illustrating a configuration example of each terminal device 100 according to the first embodiment of the present disclosure. FIG. 9 is a block diagram illustrating a configuration example of a sensor unit 120 according to the first embodiment of the present disclosure. FIGS. 7 to 9 illustrate only component elements necessary for description of the features of the present embodiment, and descriptions of general component elements are omitted.

In other words, the component elements illustrated in FIGS. 7 to 9 show functional concepts and are not necessarily physically configured as illustrated. For example, specific forms of distribution or integration of blocks are not limited to those illustrated, and all or some thereof can be configured by being functionally or physically distributed or integrated, in any units, according to various loads or usage conditions.

Furthermore, in the description with reference to FIGS. 7 to 9, the description of component elements having been already described may be simplified or omitted. As illustrated in FIG. 7, the information processing system 1 includes the server device 10 and the terminal device 100.

### 1-2-1. Configuration of Server Device

The server device 10 includes a communication unit 11, a storage unit 12, and a control unit 13. The communication unit 11 is implemented by, for example, a network interface card (NIC) or the like. The communication unit 11 is wirelessly connected to the terminal device 100 and transmits and receives information to and from the terminal device 100.

The storage unit 12 is implemented by, for example, a semiconductor memory device such as a random access memory (RAM), read only memory (ROM), or flash memory, or a storage device such as a hard disk or optical disk. The storage unit 12 stores, for example, various programs operating in the server device 10, content provided to the terminal device 100, the map DB, various parameters of an individual identification algorithm and a posture estimation algorithm to be used, and the like.

The control unit 13 is a controller, and is implemented by, for example, executing various programs stored in the storage unit 12 by a central processing unit (CPU), a micro processing unit (MPU), or the like, with the RAM as a working area. In addition, the control unit 13 can be implemented by an integrated circuit such as an application specific integrated circuit (ASIC) or a field programmable gate array (FPGA).

The control unit 13 includes an acquisition unit 13a, an instruction unit 13b, an identification unit 13c, and an estimation unit 13d, and implements or executes the functions and operations of information processing which are described below.

The acquisition unit 13a acquires the rescue signal described above from the terminal device 100 of the user A via the communication unit 11. Furthermore, the acquisition unit 13a acquires the image of the user A from the terminal device 100 of the user B via the communication unit 11.

When the rescue signal from the user A is acquired by the acquisition unit 13a, the instruction unit 13b instructs the user A to take wait action as described above, via the communication unit 11. Furthermore, the instruction unit 13b instructs the user A to take wait action, and further instructs the user B to take help/support action via the communication unit 11.

Here, the examples of the wait action instruction for the user A and the examples of the help/support action instruction for the user B will be described with reference to FIGS. 10 and 11. FIG. 10 is a table illustrating the examples of the wait action instruction. Furthermore, FIG. 11 is a table illustrating the examples of the help/support action instruction.

The server device 10 instructs the user A to take wait action as illustrated in FIG. 10. As illustrated in the drawing, for example, the server device 10 causes the display unit 140 of the user A to display an instruction “Please do not move” (hereinafter, sometimes referred to as “stay still”).

Furthermore, as illustrated in the drawing, for example, the server device 10 causes the display unit 140 of the user A to display an instruction “please look to user B” (hereinafter, sometimes referred to as “specifying the direction”). Furthermore, as illustrated in the drawing, for example, the server device 10 causes the display unit 140 of the user A to display an instruction “Please step in place” (hereinafter, sometimes referred to as “stepping”)

These instruction contents are switched according to the individual identification algorithm and posture estimation algorithm to be used. Note that these instruction contents may be switched according to the type of the LBE game, a relationship between the users, or the like.

In addition, the server device 10 instructs the user B to take help/support action as illustrated in FIG. 11. As illustrated in the drawing, for example, the server device 10 causes the display unit 140 of the user B to display an instruction “Please look to user A”.

Furthermore, as illustrated in the drawing, for example, the server device 10 does not cause the display unit 140 of the user B to display a direct instruction, but to indirectly guide the user B to look to the user A such as by moving the virtual object displayed on the display unit 140 of the user B toward the user A.

Furthermore, as illustrated in the drawing, for example, the server device 10 guides the user B to look to the user A with sound emitted from the speaker 150. Such indirect instructions make it possible to prevent the reduction of the experience value of the user B. In addition, although the direct instruction reduces the experience value of the user B for a moment, there is an advantage that the direct instruction can be reliably given to the user B.

Note that the content may include a mechanism that gives the user B an incentive upon looking to the user A.

Returning to FIG. 7, the identification unit 13c will be described next. When the image from the user B is acquired by the acquisition unit 13a, the identification unit 13c identifies the user A in the image by using a predetermined individual identification algorithm, on the basis of the image.

The identification unit 13c basically identifies the user A on the basis of the self-position acquired from the user A and the degree of the user A being shown in the center portion of the image, but for an increased identification rate, clothing, height, a marker, a light emitting diode (LED), gait analysis, or the like can be secondarily used. The gait analysis is a known method of finding so-called characteristics of walking. What is used in such identification is selected according to the wait action instruction illustrated in FIG. 10.

Here, examples of the individual identification method are illustrated in FIG. 12. FIG. 12 is a table illustrating the examples of the individual identification method. FIG. 12 illustrates compatibility between each example and each wait action instruction, advantages and disadvantages of each example, and necessary data required in each example.

In an example, for example, the marker or the LED is not visible from all directions, and therefore, “specifying the direction” is preferably used, as the wait action instruction for the user A, so that the marker or the LED is visible from the user B.

Returning to FIG. 7 the estimation unit 13d will be described next. When the image from the user B is acquired by the acquisition unit 13a, the estimation unit 13d estimates the posture of the user A (more precisely, the posture of the terminal device 100 of the user A) by using a predetermined posture estimation algorithm, on the basis of the image.

The estimation unit 13d basically estimates the rough posture of the user A on the basis of the self-position of the user B, when the user A is facing toward the user B. The estimation unit 13d is configured to recognize the front surface of the terminal device 100 of the user A in the image on the basis of the user A looking to the user B, and therefore, for an increased accuracy, the posture can be estimated by recognition of the device. The marker or the like may be used. Furthermore, the posture of the user A may be indirectly estimated from the skeletal frame of the user A by a so-called bone estimation algorithm.

What is used in such estimation is selected according to the wait action instruction illustrated in FIG. 10. Here, the examples of the posture estimation method is illustrated in FIG. 13. FIG. 13 is a table illustrating the examples of the posture estimation method. FIG. 13 illustrates compatibility between each example and each wait action instruction, advantages and disadvantages of each example, and necessary data required in each example.

Note that in the bone estimation, the “stay still” without “specifying the direction” may not distinguish the front side from the back side of a person, and thus, the wait action instruction preferably has a combination of the “specifying the direction” with the “stepping”.

Returning to FIG. 7, the description of the estimation unit 13d will be continued. Furthermore, the estimation unit 13d transmits a result of the estimation to the user A via the communication unit 11.

### 1-2-2. Configuration of Terminal Device

Next, the configuration of each terminal device 100 will be described. As illustrated in FIG. 8, the terminal device 100 includes a communication unit 110, the sensor unit 120, a microphone 130, the display unit 140, the speaker 150, a storage unit 160, and a control unit 170. The communication unit 110 is implemented by, for example, NIC or the like, as in the communication unit 11 described above. The communication unit 110 is wirelessly connected to the server device 10 and transmits and receives information to and from the server device 10.

The sensor unit 120 includes various sensors that acquire situations around the users wearing the terminal devices 100. As illustrated in FIG. 9, the sensor unit 120 includes the camera 121, a depth sensor 122, the gyro sensor 123, the acceleration sensor 124, an orientation sensor 125, and a position sensor 126.

The camera 121 is, for example, a monochrome stereo camera, and images a portion in front of the terminal device 100. Furthermore, the camera 121 uses an imaging element such as a complementary metal oxide semiconductor (CMOS) or a charge coupled device (CCD) to capture an image. Furthermore, the camera 121 photoelectrically converts light received by the imaging element and performs analog/digital (A/D) conversion to generate the image.

Furthermore, the camera 121 outputs the captured image that is a stereo image, to the control unit 170. The captured image output from the camera 121 is used for self-localization using, for example, SLAM in a determination unit 171 which is described later, and further, the captured image obtained by imaging the user A is transmitted to the server device 10. when the terminal device 100 receives the help/support action instruction from the server device 10. Note that the camera 121 may be mounted with a wide-angle lens or a fisheye lens.

The depth sensor 122 is, for example, a monochrome stereo camera similar to the camera 121, and images a portion in front of the terminal device 100. The depth sensor 122 outputs a captured image that is a stereo image, to the control unit 170. The captured image output from the depth sensor 122 is used to calculate a distance to a subject positioned in a line-of-sight direction of the user. Note that the depth sensor 122 may use a time of flight (TOF) sensor.

The gyro sensor 123 is a sensor that detects a direction of the terminal device 100, that is, a direction of the user. For the gyro sensor 123, for example, a vibration gyro sensor can be used.

The acceleration sensor 124 is a sensor that detects acceleration in each direction of the terminal device 100. For the acceleration sensor 124, for example, a piezoresistive or capacitance 3-axis accelerometer can be used.

The orientation sensor 125 is a sensor that detects an orientation in the terminal device 100. For the orientation sensor 125, for example, a magnetic sensor can be used.

The position sensor 126 is a sensor that detects the position of the terminal device 100, that is, the position of the user. The position sensor 126 is, for example, a global positioning system (GPS) receiver and detects the position of the user on the basis of a received GPS signal.

Returning to FIG. 8, the microphone 130 will be described next. The microphone 130 is a voice input device and inputs user's voice information and the like. The display unit 140 and the speaker 150 have already been described, and the descriptions thereof are omitted here.

The storage unit 160 is implemented by, for example, a semiconductor memory device such as RAM, ROM, or a flash memory, or a storage device such as a hard disk or optical disk, as in the storage unit 12 described above. The storage unit 160 stores, for example, various programs operating in the terminal device 100, the map DB, and the like.

As in the control unit 13 described above, the control unit 170 is a controller, and is implemented by, for example, executing various programs stored in the storage unit 160 by CPU, MPU, or the like, with RAM as a working area. Furthermore, the control unit 170 can be implemented by an integrated circuit such as ASIC or FPGA.

The control unit 170 includes a determination unit 171, a transmission unit 172, an output control unit 173, an acquisition unit 174, and a correction unit 175, and implements or executes the functions and operations of information processing which are described below.

The determination unit 171 always performs self-localization using SLAM on the basis of a detection result from the sensor unit 120, and causes the transmission unit 172 to transmit the localized self-position to the server device 10. In addition, the determination unit 171 always calculates the reliability of SLAM and determines whether the calculated reliability of SLAM is equal to or less than the predetermined value.

In addition, when the reliability of SLAM is equal to or less than the predetermined value, the determination unit 171 causes the transmission unit 172 to transmit the rescue signal described above to the server device 10. Furthermore, when the reliability of SLAM is equal to or less than the predetermined value, the determination unit 171 causes the output control unit 173 to erase the virtual object displayed on the display unit 140.

The transmission unit 172 transmits the self-position localized by the determination unit 171 and the rescue signal output when the reliability of SLAM becomes equal to or less than the predetermined value, to the server device 10 via the communication unit 110.

When the reduction in the reliability of SLAM is detected by the determination unit 171, the output control unit 173 erases the virtual object displayed on the display unit 140.

In addition, when a specific action instruction from the server device 10 is acquired by the acquisition unit 174, the output control unit 173 controls output of display on the display unit 140 and/or voice to the speaker 150, on the basis of the action instruction. The specific action instruction is the wait action instruction for the user A or the help/support action instruction for the user B, which is described above.

In addition, the output control unit 173 displays the virtual object on the display unit 140 when returning from the lost state.

The acquisition unit 174 acquires the specific action instruction from the server device 10 via the communication unit 110, and causes the output control unit 173 to control output on the display unit 140 and the speaker 150 according to the action instruction.

Furthermore, when the acquired specific action instruction is the help/support action instruction for the user B, the acquisition unit 174 acquires the image including the user A captured by the camera 121 from the camera 121, and causes the transmission unit 172 to transmit the acquired image to the server device 10.

Furthermore, the acquisition unit 174 acquires results of the estimation of the position and posture of the user A based on the transmitted image, and outputs the acquired results of the estimation to the correction unit 175.

The correction unit 175 corrects the self-position on the basis of the results of the estimation acquired by the acquisition unit 174. Note that the correction unit 175 determines the state of the determination unit 171 before correction of the self-position, and resets SLAM in the determination unit 171 to at least the “quasi-lost state” when the state has the “completely lost state”.

### 1-3. Procedure of Process Performed by Information Processing System

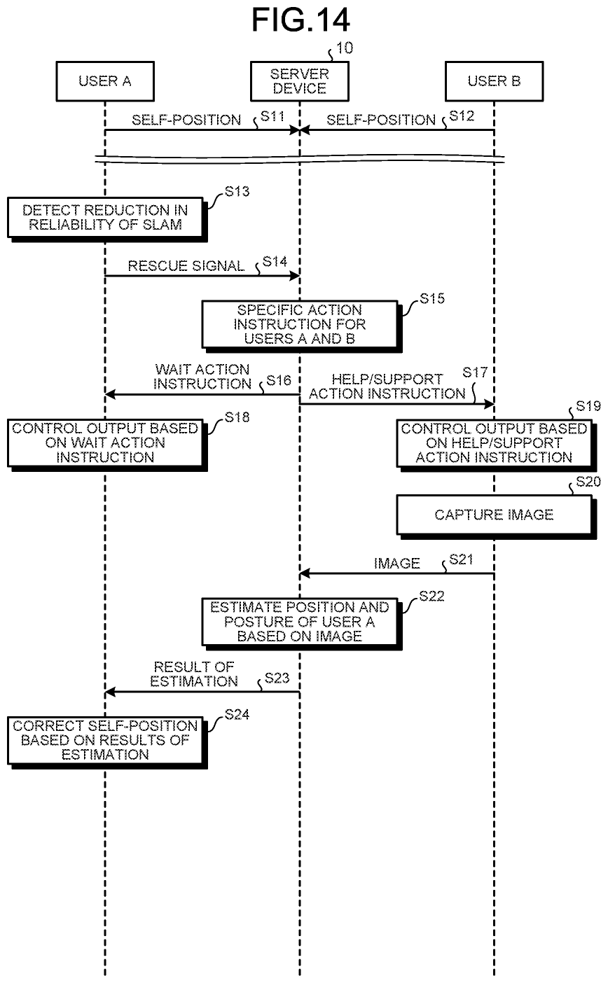

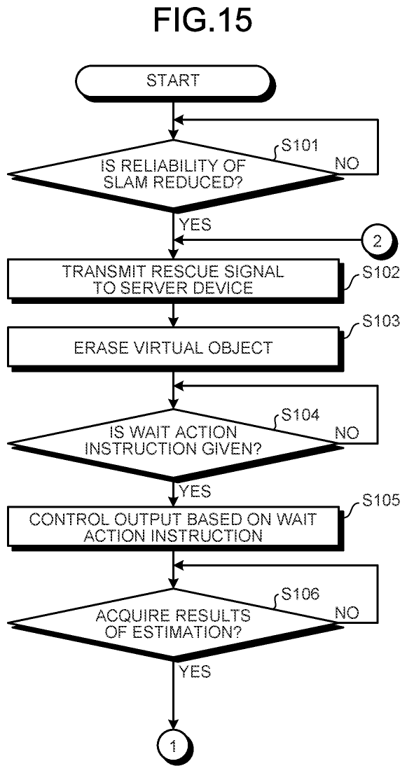

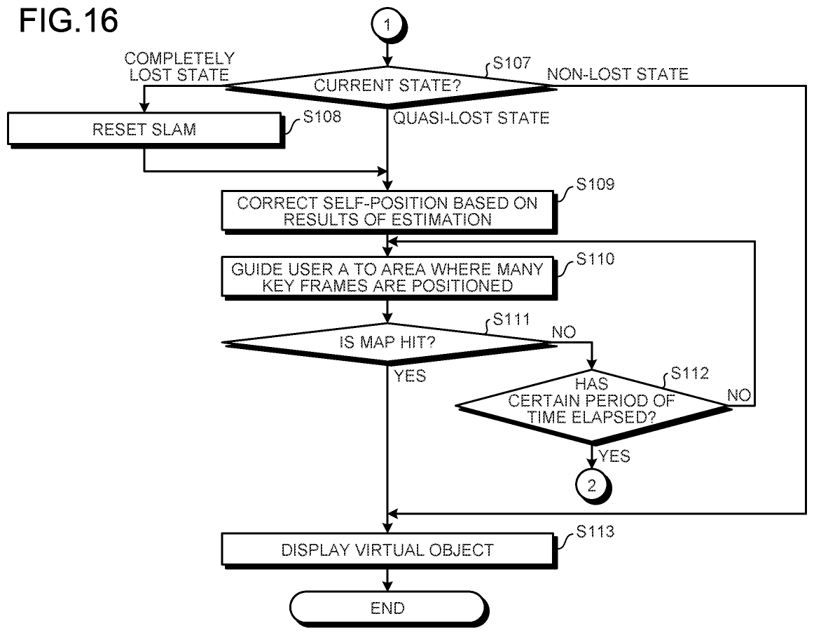

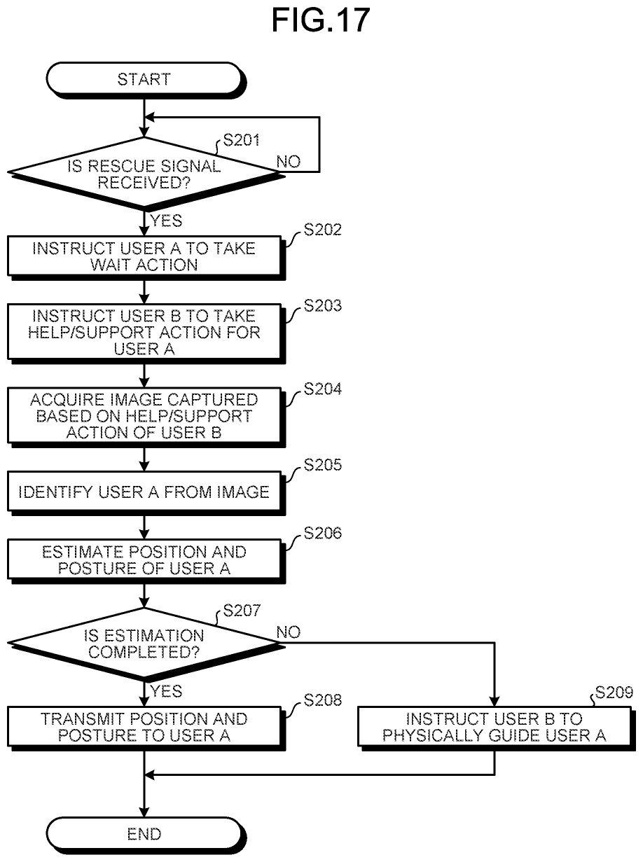

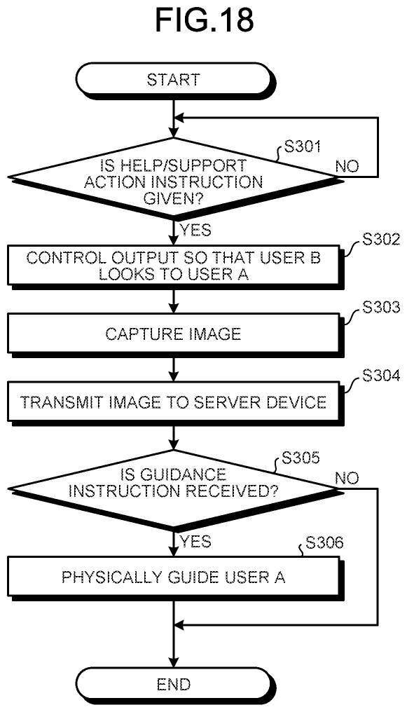

Next, a procedure of a process performed by the information processing system 1 according to the first embodiment will be described with reference to FIGS. 14 to 18. FIG. 14 is a sequence diagram of a process performed by the information processing system 1 according to the first embodiment. Furthermore, FIG. 15 is a flowchart (No. 1) illustrating a procedure of a process for the user A. Furthermore, FIG. 16 is a flowchart (No. 2) illustrating the procedure of the process for the user A. Furthermore, FIG. 17 is a flowchart illustrating a procedure of a process by the server device 10. Furthermore, FIG. 18 is a flowchart illustrating a procedure of a process for the user B.

### 1-3-1. Overall Processing Sequence

As illustrated in FIG. 14, each of the user A and the user B performs self-localization by SLAM first, and constantly transmits the localized self-position to the server device 10 (Steps S11 and S12).

Here, it is assumed that the user A detects a reduction in the reliability of SLAM (Step S13). Then, the user A transmits the rescue signal to the server device 10 (Step S14).

Upon receiving the rescue signal, the server device 10 gives the specific action instructions to the users A and B (Step S15). The server device 10 transmits the wait action instruction to the user A (Step S16). The server device 10 transmits the help/support action instruction to the user B (Step S17).

Then, the user A controls output for the display unit 140 and/or the speaker 150 on the basis of the wait action instruction (Step S18). Meanwhile, the user B controls output for the display unit 140 and/or the speaker 150 on the basis of the help/support action instruction (Step S19).

Then, when the angle of view of the camera 121 captures the user A for the certain period of time on the basis of the control of output performed in Step S19, an image is captured by the user B (Step S20). Then, the user B transmits the captured image to the server device 10 (Step S21).

When receiving the image, the server device 10 estimates the position and posture of the user A on the basis of the image (Step S22). Then, the server device 10 transmits the results of the estimation to the user A (Step S23).

Then, upon receiving the results of the estimation, the user A corrects the self-position on the basis of the results of the estimation (Step S24). After the correction, for example, the user A is guided to the area where many key frames are positioned so as to hit the map, and returns to the “non-lost state”.

### 1-3-2. Procedure of Process for User A

The process content described with reference to FIG. 14 will be described below more specifically. First, as illustrated in FIG. 15, the user A determines whether the determination unit 171 detects the reduction in the reliability of SLAM (Step S101).

Here, when there is no reduction in the reliability (Step S101, No), Step S101 is repeated. On the other hand, when there is a reduction in the reliability (Step S101, Yes), the transmission unit 172 transmits the rescue signal to the server device 10 (Step S102).

Then, the output control unit 173 erases the virtual object displayed on the display unit 140 (Step S103). Then, the acquisition unit 174 determines whether the wait action instruction is acquired from the server device 10 (Step S104).

Here, when there is no wait action instruction (Step S104, No), Step S104 is repeated. On the other hand, when the wait action instruction is received (Step S104, Yes), the output control unit 173 controls output on the basis of the wait action instruction (Step S105).

Subsequently, the acquisition unit 174 determines whether the results of the estimation of the position and posture of the user A is acquired from the server device 10 (Step S106). Here, when the results of the estimation are not acquired (Step S106, No), Step S106 is repeated.

On the other hand, when the results of the estimation are acquired (Step S106, Yes), the correction unit 175 determines a current state (Step S107), as illustrated in FIG. 16. Here, when the current state has the “completely lost state”, the determination unit 171 resets SLAM (Step S108).

Then, the correction unit 175 corrects the self-position on the basis of the acquired results of the estimation (Step S109). When the current state has the “quasi-lost state” in Step S107, Step S109 is executed as well.

Then, after the correction of the self-position, the output control unit 173 controls output control to guide the user A to the area where many key frames are positioned (Step S110). As a result of guiding, when the map is hit (Step S111, Yes), the state transitions to the “non-lost state”, and the output control unit 173 causes the display unit 140 to display the virtual object (Step S113).

On the other hand, when no map is hit in Step S111 (Step S111, No), if a certain period of time has not elapsed (Step S112, No), the process is repeated from Step S110. If the certain period of time has elapsed (Step S112, Yes), the process is repeated from Step S102.

### 1-3-3. Procedure of Process in Server Device

Next, as illustrated in FIG. 17, in the server device 10, the acquisition unit 13a determines whether the rescue signal from the user A is received (Step S201).

Here, when no rescue signal is received (Step S201, No), Step S201 is repeated. On the other hand, when the rescue signal is received (Step S201, Yes), the instruction unit 13b instructs the user A to take wait action (Step S202).

Furthermore, the instruction unit 13b instructs the user B to take help/support action for the user A (Step S203). Then, the acquisition unit 13a acquires an image captured on the basis of the help/support action of the user B (Step S204).

Then, the identification unit 13c identifies the user A from the image (Step S205), and the estimation unit 13d estimates the position and posture of the identified user A (Step S206). Then, it is determined whether the estimation is completed (Step S207).

Here, when the estimation is completed (Step S207, Yes), the estimation unit 13d transmits the results of the estimation to the user A (Step S208), and the process is finished. On the other hand, when the estimation cannot be completed (Step S207, No), the instruction unit 13b instructs the user B to physically guide the user A (Step S209), and the process is finished.

Note that “the estimation cannot be completed” means that, for example, the user A in the image cannot be identified due to movement of the user A or the like and the estimation of the position and posture fails.

In that case, instead of estimating the position and posture of the user A, the server device 10, for example, displays an area where the map is likely to be hit on the display unit 140 of the user B and transmits a guidance instruction to the user B to guide the user A to the area. The user B who receives the guidance instruction guides the user A, for example, while speaking to the user A.

### 1-3-4. Procedure of Process for User B

Next, as illustrated in FIG. 18, the user B determines whether the acquisition unit 174 receives the help/support action instruction from the server device 10 (Step S301). Here, when the help/support action instruction is not received (Step S301, No), Step S301 is repeated.

On the other hand, when the help/support action instruction is received (Step S301, Yes), the output control unit 173 controls output for the display unit 140 and/or the speaker 150 so that the user B looks to the user A (Step S302).

As a result of the control of output, when the angle of view of the camera 121 captures the user A for the certain period of time, the camera 121 captures an image including the user A (Step S303). Then, the transmission unit 172 transmits the image to the server device 10 (Step S304).

In addition, the acquisition unit 174 determines whether the guidance instruction to guide the user A is received from the server device 10 (Step S305). Here, when the guidance instruction is received (Step S305, Yes), the output control unit 173 controls output to the display unit 140 and/or the speaker 150 so that the user A may be physically guided (Step S306), and the process is finished. When the guidance instruction is not received (Step S305, No), the process is finished.

### 1-4. Modifications

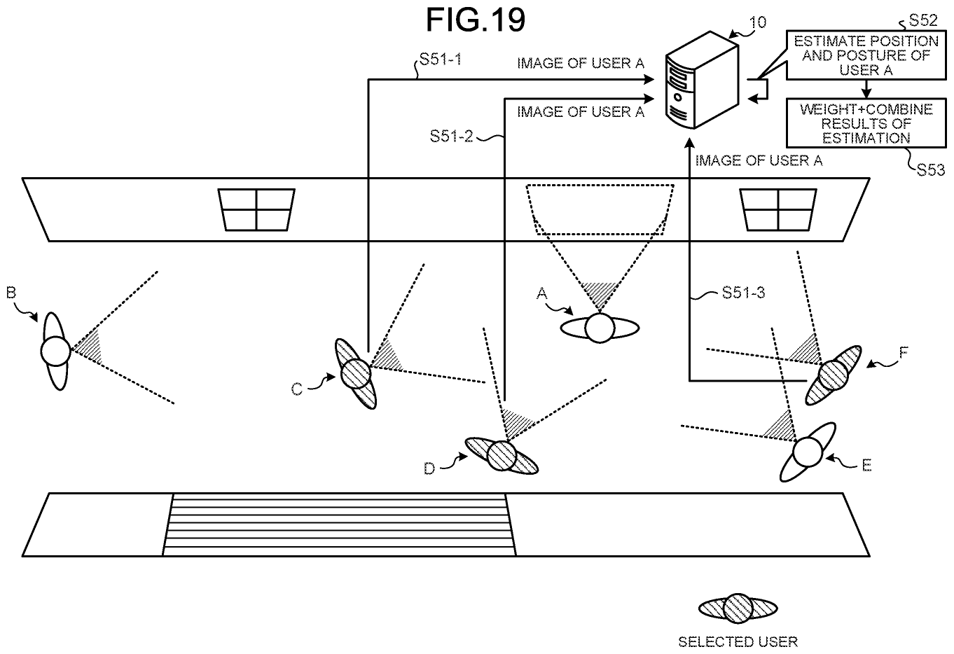

Incidentally, in the above example, two users A and B, the user A being the person who needs help and the user B being the person who gives help/support, are described, but the first embodiment described above is applicable to three or more users. This case will be described as a first modification with reference to FIG. 19.

### 1-4-1. First Modification

FIG. 19 is an explanatory diagram of a process according to the first modification. Here, it is assumed that there are six users A to F, and, as in the above embodiment, the user A is the person who needs help. In this case, the server device 10 “selects” a user to be the person who gives help/support, on the basis of the self-positions always received from the users.

In the selection, the server device 10 selects, for example, a user who is closer to the user A and can see the user A from a unique angle. In the example of FIG. 19, it is assumed that selected users who are selected in this manner are the users C, D, and F.

Then, the server device 10 transmits the help/support action instruction described above to each of the users C, D, and F and acquires images of the user A captured from various angles from the users C, D, and F (Steps S51-1, S51-2, and S51-3).

Then, the server device 10 performs processes of individual identification and posture estimation which are described above, on the basis of the acquired images captured from the plurality of angles, and estimates the position and posture of the user A (Step S52).

Then, the server device 10 weights and combines the respective results of the estimation (Step S53). The weighting is performed, for example, on the basis of the reliability of SLAM of the users C, D, and F, and the distances, angles, and the like to the user A.

Therefore, the position of the user A can be estimated more accurately when the number of users is large as compared with when the number of users is small.

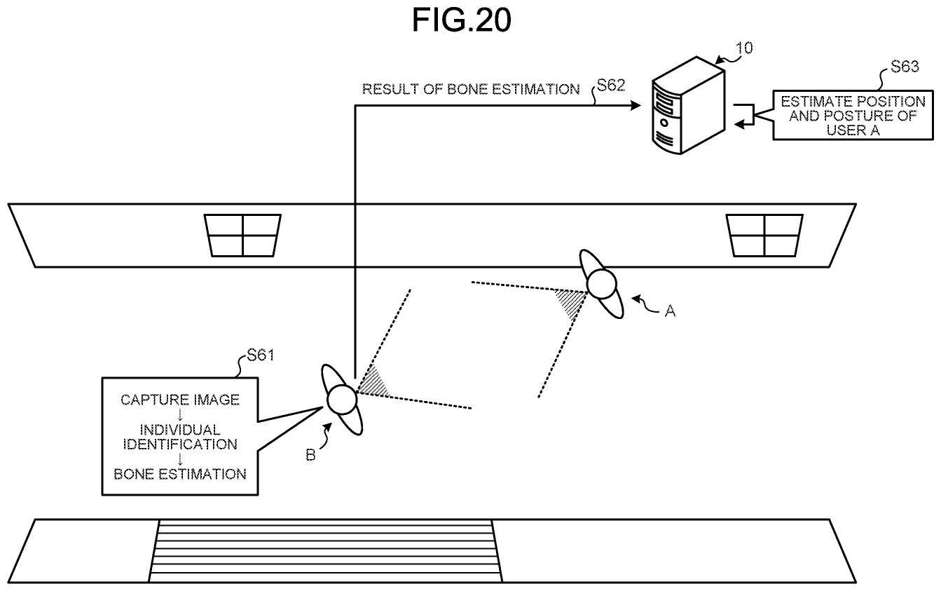

Furthermore, in the above description the server device 10 receives provision of an image from, for example, the user B who is the person who gives help/support and performs the processes of individual identification and posture estimation on the basis of the image, but the processes of individual identification and posture estimation may also be performed by the user B. This case will be described as a second modification with reference to FIG. 20.

### 1-4-2. Second Modification

FIG. 20 is an explanatory diagram of a process according to the second modification. Here, it is assumed that there are two users A and B, and, as in the above embodiment, the user A is the person who needs help.

In the second modification, after capturing an image of the user A, the user B performs the individual identification and the posture estimation (here, the bone estimation) on the basis of the image, instead of sending the image to the server device 10 (Step S61), and transmits a result of the bone estimation to the server device 10 (Step S62).

Then, the server device 10 estimates the position and posture of the user on the basis of the received result of the bone estimation (Step S63), and transmits the results of the estimation to the user A. In the second modification, data transmitted from the user B to the server device 10 is only coordinate data of the result of the bone estimation, and thus, data amount can be considerably reduced as compared with the image, and a communication band can be greatly reduced.

Therefore, the second modification can be used in a situation or the like where there is a margin in a calculation resource of each user but communication is greatly restricted in load.

### 1-4-3. Other Modifications

Other modifications can be made. For example, the server device 10 may be a fixed device, or the terminal device 100 may also have the function of the server device 10. In this configuration, for example, the terminal device 100 may be a terminal device 100 of the user as the person who gives help/support or a terminal device 100 of a staff member.

Furthermore, the camera 121 that captures an image of the user A as the person who needs help is not limited to the camera 121 of the terminal device 100 of the user B, and may use a camera 121 of the terminal device 100 of the staff member or another camera provided outside the terminal device 100. In this case, although the number of cameras increases, the experience value of the user B is not reduced.

### 2. Second Embodiment

### 2-1. Overview

Incidentally, in the first embodiment, it has been described that the terminal device 100 has the “quasi-lost state”, that is, the “lost state” at first upon activation (see FIG. 5), and at this time, for example, it is possible to determine that the reliability of SLAM is low. In this case, even if the virtual object has low accuracy (e.g., displacement of several tens of centimeters), coordinate systems may be mutually shared between the terminal devices 100 tentatively at any place to quickly share the virtual object between the terminal devices 100.

Therefore, in an information processing method according to a second embodiment of the present disclosure, sensing data including an image obtained by capturing a user who uses a first presentation device that presents content in a predetermined three-dimensional coordinate system is acquired from a sensor provided in a second presentation device different from the first presentation device, first position information about the user is estimated on the basis of a state of the user indicated by the sensing data, second position information about the second presentation device is estimated on the basis of the sensing data, and the first position information and the second position information are transmitted to the first presentation device.

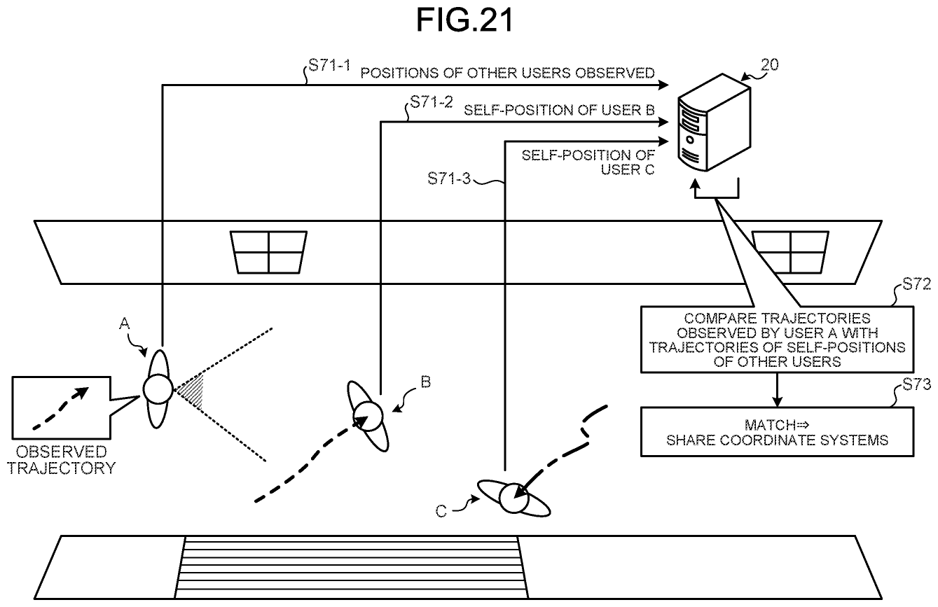

FIG. 21 is a diagram illustrating an overview of the information processing method according to the second embodiment of the present disclosure. Note that in the second embodiment, a server device is denoted by reference numeral “20”, and a terminal device is denoted by reference numeral “200”. The server device 20 corresponds to the server device 10 of the first embodiment, and the terminal device 200 corresponds to the terminal device 100 of the first embodiment. As in the terminal device 100, in the following, the description, such as user A or user B, may represent the terminal device 200 worn by each user.

Schematically, in the information processing method according to the second embodiment, the self-position is not estimated from the feature points of a stationary object such as a floor or a wall, but a trajectory of a self-position of a terminal device worn by each user is compared with a trajectory of a portion of another user (hereinafter, appropriately referred to as “another person's body part”) observed by each user. Then, when trajectories that match each other are detected, a transformation matrix for transforming coordinate systems between the users whose trajectories match is generated, and the coordinate systems are mutually shared between the users. The another person's body part is a head if the terminal device 200 is, for example, an HMD and is a hand if the terminal device is a mobile device such as a smartphone or a tablet.

FIG. 21 schematically illustrates that the user A observes other users from a viewpoint of the user A, that is, the terminal device 200 worn by the user A is a “viewpoint terminal”. Specifically, as illustrated in FIG. 21, in the information processing method according to the second embodiment, the server device 20 acquires the positions of the other users observed by the user A, from the user A as needed (Step S71-1).

Furthermore, the server device 20 acquires a self-position of the user B, from the user B wearing a “candidate terminal” being a terminal device 200 with which the user A mutually shares coordinate systems (Step S71-2). Furthermore, the server device 20 acquires a self-position of a user C, from the user C similarly wearing a “candidate terminal” (Step S71-3).

Then, the server device 20 compares trajectories that are time-series data of the positions of the other users observed by the user A with trajectories that are the time-series data of the self-positions of the other users (here, the users B and C) (Step S72). Note that the comparison targets are trajectories in the same time slot.

Then, when the trajectories match each other, the server device 20 causes the users whose trajectories match each other to mutually share the coordinate systems (Step S73). As illustrated in FIG. 21, when a trajectory observed by the user A matches a trajectory of the self-position of the user B, the server device 20 generates the transformation matrix for transforming a local coordinate system of the user A into a local coordinate system of the user B, transmits the transformation matrix to the user A, and causes the terminal device 200 of the user A to use the transformation matrix for control of output. Therefore the coordinate systems are mutually shared.

Note that although FIG. 21 illustrates an example in which the user A has the viewpoint terminal, the same applies to a case where the viewpoint terminals are used by the users B and C. The server device 20 sequentially selects, as the viewpoint terminal, a terminal device 200 of each user to be connected, and repeats steps S71 to S73 until there is no terminal device 200 whose coordinate system is not shared.

Therefore, for example, when a terminal device 200 is in the “quasi-lost state” immediately after activation or the like, it is possible for the terminal device 200 to quickly share the coordinate systems mutually with another terminal device 200 and shares the virtual object between the terminal devices 200. Note that the server device 20 may performs the information processing according to the second embodiment appropriately, not only when the terminal device 200 is in the “quasi-lost state” but also, for example, connection of a new user is detected or arrival of periodic timing is detected. A configuration example of an information processing system 1A to which the information processing method according to the second embodiment described above is applied will be described below more specifically.

### 2-2. Configuration of Information Processing System

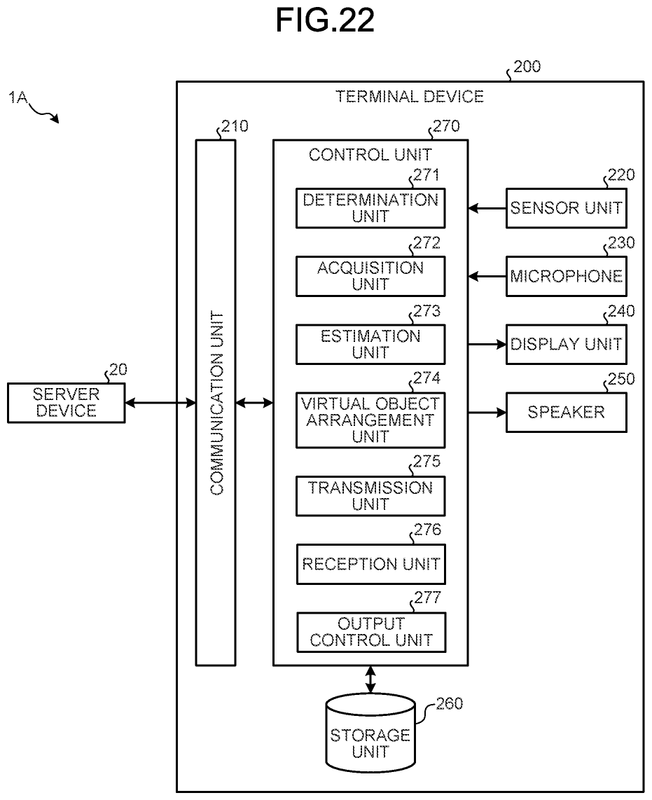

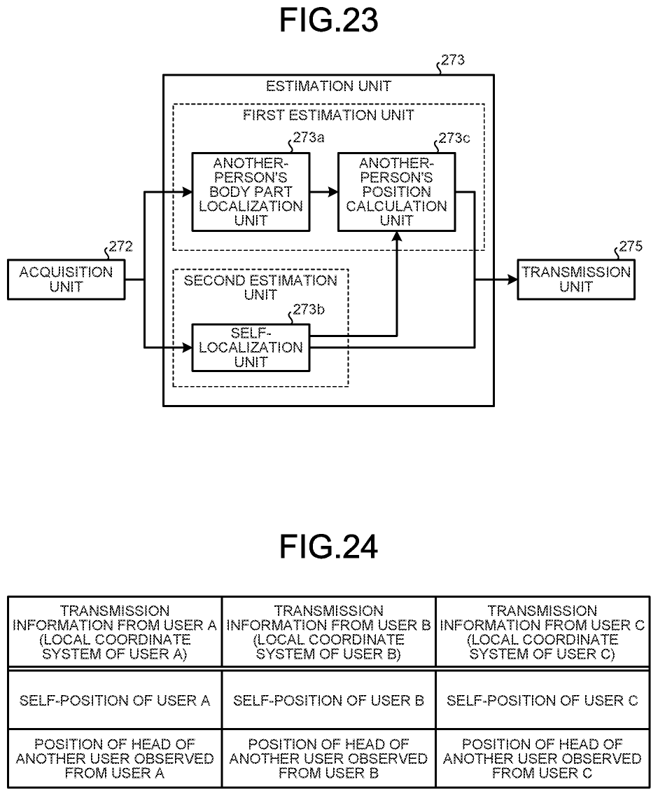

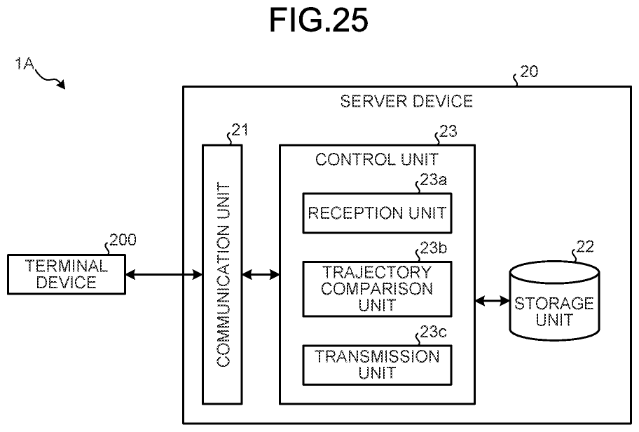

FIG. 22 is a block diagram illustrating a configuration example of the terminal device 200 according to the second embodiment of the present disclosure. Furthermore, FIG. 23 is a block diagram illustrating a configuration example of an estimation unit 273 according to the second embodiment of the present disclosure. Furthermore, FIG. 25 is an explanatory diagram of transmission information transmitted by each user. FIG. 25 is a block diagram illustrating a configuration example of the server device 20 according to the second embodiment of the present disclosure.

A schematic configuration of the information processing system 1A according to the second embodiment is similar to that of the first embodiment illustrated in FIGS. 1 and 2. Furthermore, as described above, the terminal device 200 corresponds to the terminal device 100.

Therefore, a communication unit 210, a sensor unit 220, a microphone 230, a display unit 240, a speaker 250, a storage unit 260, and a control unit 270 of the terminal device 200 illustrated in FIG. 22 correspond to the communication unit 110, the sensor unit 120, the microphone 130, the display unit 140, the speaker 150, the storage unit 160, and the control unit 170, which are illustrated in FIG. 8, in this order, respectively. Furthermore, a communication unit 21, a storage unit 22, and a control unit 23 of the server device 20 illustrated in FIG. 25 correspond to the communication unit 11, the storage unit 12, and the control unit 13, which are illustrated in FIG. 7, in this order, respectively. Differences from the first embodiment will be mainly described below.

### 2-2-1. Configuration of Terminal Device

As illustrated in FIG. 22, the control unit 270 of the terminal device 200 includes a determination unit 271, an acquisition unit 272, the estimation unit 273, a virtual object arrangement unit 274, a transmission unit 275, a reception unit 276, an output control unit 277, and implements or performs the functions and operations of image processing which are described below.

The determination unit 271 determines the reliability of self-localization as in the determination unit 171 described above. In an example, when the reliability is equal to or less than a predetermined value, the determination unit 271 notifies the server device 20 of the reliability via the transmission unit 275, and causes the server device 20 to perform trajectory comparison process which is described later.

The acquisition unit 272 acquires sensing data of the sensor unit 220. The sensing data includes an image obtained by capturing another user. The acquisition unit 272 also outputs the acquired sensing data to the estimation unit 273.

The estimation unit 273 estimates another person's position that is the position of another user and the self-position on the basis of the sensing data acquired by the acquisition unit 272. As illustrated in FIG. 23, the estimation unit 273 includes an another-person's body part localization unit 273a, a self-localization unit 273b, and an another-person's position calculation unit 273c. The another-person's body part localization unit 273a and the another-person's position calculation unit 273c correspond to examples of a “first estimation unit”. The self-localization unit 273b corresponds to an example of a “second estimation unit”.

The another-person's body part localization unit 273a estimates a three-dimensional position of the another person's body part described above, on the basis of the image including the another user included in the sensing data. For the estimation, the bone estimation described above may be used, or object recognition may be used. The another-person's body part localization unit 273a estimates the three-dimensional position of the head or hand of the another user with the imaging point as the origin, from the position of the image, an internal parameter of a camera of the sensor unit 220, and depth information obtained by a depth sensor. Furthermore, the another-person's body part localization unit 273a may use pose estimation (OpenPose etc.) by machine learning using the image as an input.

Note that, here, tracking of other users is possible, even if individual identification of other users may not be possible. In other words, it is assumed that the identical “head” and “hand” are associated before and after the captured image.

The self-localization unit 273b estimates the self-position (pose=position and rotation) from the sensing data. For the estimation, the VIO, SLAM, or the like described above may be used. The origin of the coordinate system is a point where the terminal device 200 is activated, and the direction of the axis is often determined in advance. Usually, the coordinate systems (i.e., the local coordinate systems) do not match between the terminal devices 200. Furthermore, the self-localization unit 273b causes the transmission unit 275 to transmit the estimated self-position to the server device 20.

The another-person's position calculation unit 273c adds the position of the another person's body part estimated by the another-person's body part localization unit 273a and the relative position from the self-position estimated by the self-localization unit 273b to calculate the position of the another person's body part (hereinafter, referred to as “another person's position” appropriately) in the local coordinate system. Furthermore, the another-person's position calculation unit 273c causes the transmission unit 275 to transmit the calculated another person's position to the server device 20.

Here, as illustrated in FIG. 24, the transmission information from each of the users A, B, and C indicates each self-position represented in each local coordinate system and a position of another person's body part (here, the head) of another user observed from each user.

In a case where the user A mutually shares the coordinate systems with the user B or the user C, the server device 20 requires another person's position viewed from the user A, the self-position of the user B, and the self-position of the user C, as illustrated in FIG. 24. However, upon the transmission, the user A can only recognize the another person's position, that is, the position of “somebody”, and does not know whether “somebody” is the user B, the user C, or neither.

Note that, in the transmission information from each user illustrated in FIG. 24, information about the position of another user corresponds to the “first position information”. Furthermore, information about the self-position of each user corresponds to the “second position information”.

The description returns to FIG. 22. The virtual object arrangement unit 274 arranges the virtual object by any method. The position and attitude of the virtual object may be determined by, for example, an operation unit, not illustrated, or may be determined on the basis of a relative position to the self-position, but the values thereof are represented in the local coordinate system of each terminal device 200. A model (shape/texture) of the virtual object may be determined in advance in a program, or may be generated on the spot on the basis of an input to the operation unit or the like.

In addition, the virtual object arrangement unit 274 causes the transmission unit 275 to transmit the position and attitude of the arranged virtual object to the server device 20.

The transmission unit 275 transmits the self-position and the another person's position that are estimated by the estimation unit 273 to the server device 20. The frequency of transmission is required to such an extent that, for example, a change in the position (not the posture) of the head a person can be compared, in a trajectory comparison process which is described later. In an example, the frequency of transmission is approximately 1 to 30 Hz.

Furthermore, the transmission unit 275 transmits the model, the position, and the attitude of the virtual object arranged by the virtual object arrangement unit 274, to the server device 20. Note that the virtual object is preferably transmitted, only when the virtual object is moved, a new virtual object is generated, or the model is changed.

The reception unit 276 receives a model, the position, and the attitude of the virtual object arranged by another terminal device 200 that are transmitted from the server device

20. Therefore, the model of the virtual object is shared between the terminal devices 200, but the position and attitude of the virtual object are represented in the local coordinate system of each terminal device 200. Furthermore, the reception unit 276 outputs the received model, position, and attitude of the virtual object to the output control unit 277.

Furthermore, the reception unit 276 receives the transformation matrix of the coordinate system transmitted from the server device 20, as a result of the trajectory comparison process which is described later. Furthermore, the reception unit 276 outputs the received transformation matrix to the output control unit 277.

The output control unit 277 renders the virtual object arranged in a three-dimensional space from the viewpoint of each terminal device 200, controlling output of a two-dimensional image to be displayed on the display unit 240. The viewpoint represents the position of an user's eye in the local coordinate system. In a case where the display is divided for the right eye and the left eye, the rendering may be performed for each viewpoint a total of two times. The virtual object is given by the model received by the reception unit 276 and the position and attitude.

When the virtual object arranged by a certain terminal device 200 is arranged in another terminal device 200, the position and attitude of the virtual object are presented in the local coordinate system of the another terminal device 200, but the output control unit 277 uses the transformation matrix described above to convert the position and attitude of the virtual object into the position and attitude in its own local coordinate system.

For example, when the virtual object arranged by the user B is rendered in the terminal device 200 of the user A, the position and attitude of the virtual object represented in the local coordinate system of the user B is multiplied by the transformation matrix for performing transformation from the local coordinate system of the user B to the local coordinate system of the user A, and the position and attitude of the virtual object in the local coordinate system of the user A is obtained.

### 2-2-2. Configuration of Server Device

Next, as illustrated in FIG. 25, the control unit 23 of the server device 20 includes a reception unit 23a, a trajectory comparison unit 23b, and a transmission unit 23c, and implements or performs the functions and operations of image processing which are described below.

The reception unit 23a receives the self-position and another person's position that are transmitted from each terminal device 200. Furthermore, the reception unit 23a outputs the received self-position and another person's position to the trajectory comparison unit 23b. Furthermore, the reception unit 23a receives the model, the position, and the attitude of the virtual object transmitted from each terminal device 200.

The trajectory comparison unit 23b compares, in matching degree, trajectories that are time-series data of the self-position and the another person's position that are received by the reception unit 23a. For the comparison, iterative closest point (ICP) or the like is used, but another method may be used.

Note that the trajectories to be compared need to be in substantially the same time slot, and thus, the trajectory comparison unit 23b performs in advance preprocessing of cutting out the trajectories before the comparison. In order to determine the time in such preprocessing, the transmission information from the terminal device 200 may include the time.

In addition, in the comparison of the trajectories, there is usually no perfect matching. Therefore, the trajectory comparison unit 23b may consider that trajectories below a determination threshold that is determined in advance match each other.

Note that, in a case where the user A mutually shares the coordinate systems with the user B or the user C, the trajectory comparison unit 23b compares trajectories of other persons' positions (it is not determined whether the another person is the user B or the user C) viewed from the user A with the trajectory of the self-position of the user B first. As a result, when any of the trajectories of other persons' positions matches the trajectory of the self-position of the user B, the matching trajectory of the another person's position is associated with the user B.

Next, the trajectory comparison unit 23b further compares the rest of the trajectories of other persons' positions viewed from the user A with the trajectory of the self-position of the user C. As a result, when the rest of the rest of the trajectories of other persons' positions matches the trajectory of the self-position of the user C, the matching trajectory of the another person's position is associated with the user C.

In addition, the trajectory comparison unit 23b calculates the transformation matrices necessary for coordinate transformation of the matching trajectories. When the ICP is used to compare the trajectories, each of the transformation matrices is derived as a result of searching. The transformation matrix preferably represents rotation, translation, and scale between coordinates. Note that, in a case where the another person's body part is a hand and transformation of a right-handed coordinate system and a left-handed coordinate system is included, the scale has a positive/negative relationship.

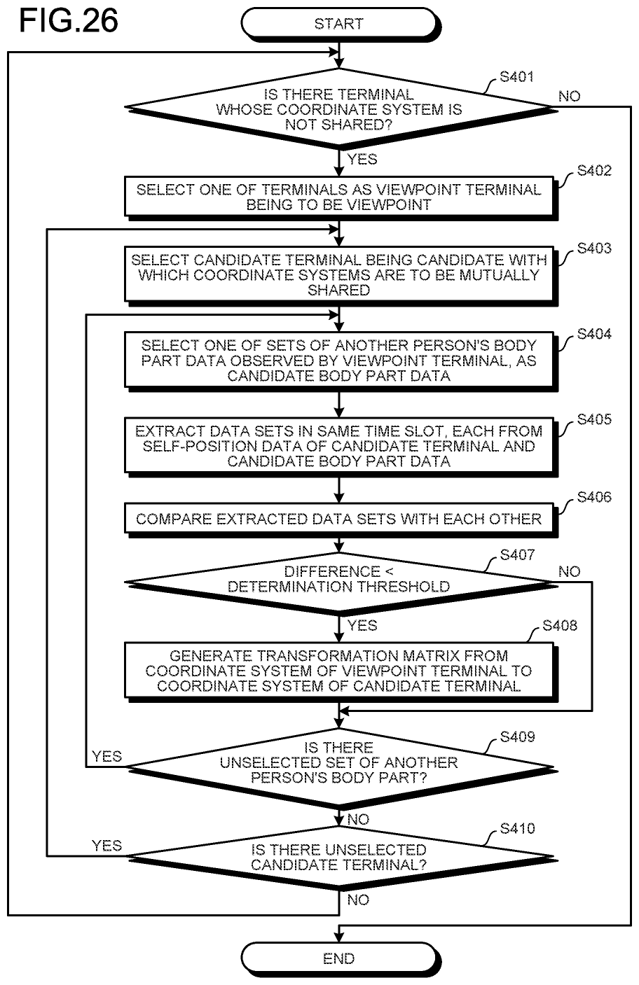

Furthermore, the trajectory comparison unit 23b causes the transmission unit 23c to transmit each of the calculated transformation matrices to the corresponding terminal device 200. A procedure of the trajectory comparison process performed by the trajectory comparison unit 23b will be described later in detail with reference to FIG. 26.

The transmission unit 23c transmits the transformation matrix calculated by the trajectory comparison unit 23b to the terminal device 200. Furthermore, the transmission unit 23c transmits the model, the position, and the attitude of the virtual object transmitted from the terminal device 200 and received by the reception unit 23a to the other terminal devices 200.

### 2-3. Process of Trajectory Comparison Process

Next, the procedure of the trajectory comparison processing performed by the trajectory comparison unit 23b will be described with reference to FIG. 26. FIG. 26 is a flowchart illustrating the procedure of the trajectory comparison process.

As illustrated in FIG. 26, the trajectory comparison unit 23b determines whether there is a terminal whose coordinate system is not shared, among the terminal devices 200 connected to the server device 20 (Step S401). When there is such a terminal (Step S401, Yes), the trajectory comparison unit 23b selects one of the terminals as the viewpoint terminal that is to be the viewpoint (Step S402).

Then, the trajectory comparison unit 23b selects the candidate terminal being a candidate with which the viewpoint terminal mutually shares the coordinate systems (Step S403). Then, the trajectory comparison unit 23b selects one of sets of “another person's body part data” that is time-series data of another person's position observed by the viewpoint terminal, as “candidate body part data” (Step S404).

Then, the trajectory comparison unit 23b extracts data sets in the same time slot, each from the “self-position data” that is time-series data of the self-position of the candidate terminal and the “candidate body part data” described above (Step S405). Then, the trajectory comparison unit 23b compares the extracted data sets with each other (Step S406), and determines whether a difference is below the predetermined determination threshold (Step S407).

Here, when the difference is below the predetermined determination threshold (Step S407, Yes), the trajectory comparison unit 23b generates the transformation matrix from the coordinate system of the viewpoint terminal to the coordinate system of the candidate terminal (Step S408), and proceeds to Step S409. When the difference is not below the predetermined determination threshold (Step S407, No), the process directly proceeds to Step S409.

Then, the trajectory comparison unit 23b determines whether there is an unselected set of “another person's body part data” among the “another person's body part data” observed by the viewpoint terminal (Step S409). Here, when there is the unselected set of “another person's body part data” (Step S409, Yes), the process is repeated from Step S404.

On the other hand, when there is no unselected set of “another person's body part data” (Step S409, No), the trajectory comparison unit 23b then determines whether there is a candidate terminal that is not selected as viewed from the viewpoint terminal (Step S410).

Here, when there is the candidate terminal not selected (Step S410, Yes), the process is repeated from Step S403. On the other hand, when there is no candidate terminal not selected (Step S410, No), the process is repeated from Step S401.

Then, when there is no terminal whose coordinate system is not shared, among the terminal devices 200 connected to the server device 20 (Step S401, No), the trajectory comparison unit 23b finishes the process.

### 2-4. Modifications

The example has been described in which the first position information and the second position information are transmitted from the terminal device 200 to the server device 20, the server device performs the trajectory comparison process on the basis of the first position information and the second position information to generate the transformation matrix, and the transformation matrix is transmitted to the terminal device 200. However, the present disclosure is not limited to the example.

For example, the first position information and the second position information may be directly transmitted between the terminals desired to mutually share the coordinate systems so that the terminal device 200 may perform processing corresponding to the trajectory comparison process on the basis of the first position information and the second position information to generate the transformation matrix.

Furthermore, in the above description, the coordinate systems are mutually shared by using the transformation matrix, but the present disclosure is not limited to the description. A relative position corresponding to a difference between the self-position and the another person's position may be calculated so that the coordinate systems may be mutually shared on the basis of the relative position.

### 3. Other Modifications

Furthermore, of the processes described in the above embodiments, all or some of processes described to be performed automatically may be performed manually, or all or some of processes described to be performed manually may be performed automatically by a known method. In addition, the procedures, specific names, and information including various data and parameters, which are described in the above description or illustrated in the drawings can be appropriately changed unless otherwise specified. For example, various information illustrated in the drawings are not limited to the illustrated information.

Furthermore, the component elements of the devices are illustrated as functional concepts and are not necessarily required to be physically configured as illustrated. In other words, specific forms of distribution or integration of the devices are not limited to those illustrated, and all or some of the devices may be configured by being functionally or physically distributed or integrated in appropriate units, according to various loads or usage conditions. For example, the identification unit 13c and the estimation unit 13d illustrated in FIG. 7 may be integrated.

Furthermore, the embodiments described above can be appropriately combined within a range consistent with the contents of the process. Furthermore, the order of the steps illustrated in each of the sequence diagram and the flowcharts of the present embodiment can be changed appropriately.

### 4. Hardware Configuration

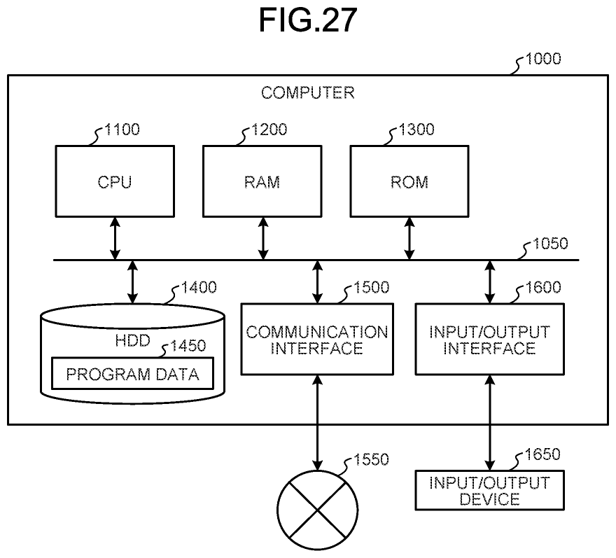

Information devices such as the server devices 10 and 20 and the terminal devices 100 and 200 according to the embodiments described above are implemented by, for example, a computer 1000 having a configuration as illustrated in FIG. 27. Hereinafter, an example of the terminal device 100 according to the first embodiment will be described. FIG. 27 is a hardware configuration diagram illustrating an example of the computer 1000 implementing the functions of the terminal device 100. The computer 1000 includes a CPU 1100, a RAM 1200, a ROM 1300, a hard disk drive (HDD) 1400, a communication interface 1500, and an input/output interface 1600. The respective units of the computer 1000 are connected by a bus 1050.

The CPU 1100 is operated on the basis of programs stored in the ROM 1300 or the HDD 1400 and controls the respective units. For example, the CPU 1100 deploys a program stored in the ROM 1300 or the HDD 1400 to the RAM 1200 and executes processing corresponding to various programs.

The ROM 1300 stores a boot program, such as a basic input output system (BIOS), executed by the CPU 1100 when the computer 1000 is booted, a program depending on the hardware of the computer 1000, and the like.

The HDD 1400 is a computer-readable recording medium that non-transitorily records programs executed by the CPU 1100, data used by the programs, and the like. Specifically, the HDD 1400 is a recording medium that records an information processing program according to the present disclosure that is an example of program data 1450.

The communication interface 1500 is an interface for connecting the computer 1000 to an external network 1550 (e.g., the Internet). For example, the CPU 1100 receives data from another device or transmits data generated by the CPU 1100 to another device, via the communication interface 1500.

The input/output interface 1600 is an interface for connecting an input/output device 1650 and the computer 1000. For example, the CPU 1100 receives data from an input device such as a keyboard or mouse via the input/output interface 1600. In addition, the CPU 1100 transmits data to an output device such as a display, speaker, or printer via the input/output interface 1600. Furthermore, the input/output interface 1600 may function as a media interface that reads a program or the like recorded on a predetermined recording medium. The medium includes, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like.

For example, when the computer 1000 functions as the terminal device 100 according to the first embodiment, the CPU 1100 of the computer 1000 implements the function of the determination unit 171 or the like by executing the information processing program loaded on the RAM 1200. Furthermore, the HDD 1400 stores the information processing program according to the present disclosure and data in the storage unit 160. Note that the CPU 1100 executes the program data 1450 read from the HDD 1400, but in another example, the CPU 1100 may acquire programs from other devices via the external network 1550.

### 5. Conclusion

As described above, according to an embodiment of the present disclosure, the terminal device 100 (corresponding to an example of the “information processing device”) includes the output control unit 173 that controls output on the presentation device (e.g., the display unit 140 and the speaker 150) so as to present content associated with the absolute position in a real space to the user A (corresponding to an example of the “first user”), the determination unit 171 that determines a self-position in the real space, the transmission unit 172 that transmits a signal requesting rescue to a terminal device 100 (corresponding to an example of a “device”) of the user B positioned in the real space when the reliability of determination by the determination unit 171 is reduced, the acquisition unit 174 that acquires, according to the signal, information about the self-position estimated from an image including the user A captured by the terminal device 100 of the user B, and the correction unit 175 that corrects the self-position on the basis of the information about the self-position acquired by the acquisition unit 174. This configuration makes it possible to implement returning of the self-position from the lost state in the content associated with the absolute position in the real space with a low load.

Furthermore, according to an embodiment of the present disclosure, the terminal device 200 (corresponding to an example of the “information processing device”) includes the acquisition unit 272 that acquires sensing data including an image obtained by capturing a user who uses a first presentation device presenting content in a predetermined three-dimensional coordinate system, from the sensor provided in a second presentation device different from the first presentation device, the another-person's body part localization unit 273a and the another-person's position calculation unit 273c (corresponding to examples of the “first estimation unit”) that estimate first position information about the user on the basis of a state of the user indicated by the sensing data, the self-localization unit 273b (corresponding to an example of the “second estimation unit”) that estimates second position information about the second presentation device on the basis of the sensing data, and the transmission unit 275 that transmits the first position information and the second position information to the first presentation device. This configuration makes it possible to implement returning of the self-position from the quasi-lost state, that is, the lost state such as after activation of the terminal device 200 in the content associated with the absolute position in the real space with a low load.

Although the embodiments of the present disclosure have been described above, the technical scope of the present disclosure is not limited to the embodiments described above and various modifications can be made without departing from the spirit and scope of the present disclosure. Moreover, the component elements in different embodiments and modifications may be suitably combined with each other.

Furthermore, the effects in the embodiments described herein are merely examples, the present invention is not limited to these effects, and other effects may also be provided.

Note that the present technology can also employ the following configurations.

(1)

An information processing device comprising:

an output control unit that controls output on a presentation device so as to present content associated with an absolute position in a real space, to a first user;

a determination unit that determines a self-position in the real space;

a transmission unit that transmits a signal requesting rescue to a device positioned in the real space, when reliability of determination by the determination unit is reduced;

an acquisition unit that acquires information about the self-position estimated from an image including the first user captured by the device according to the signal; and

a correction unit that corrects the self-position based on the information about the self-position acquired by the acquisition unit.

(2)

The information processing device according to (1), wherein

the device is another information processing device that is held by a second user to whom the content is provided together with the first user, and

a presentation device of the another information processing device

is controlled in output so as to guide at least the second user to look to the first user, based on the signal.

(3)

The information processing device according to (1) or (2), wherein

the determination unit

estimates the self-position by using simultaneous localization and mapping (SLAM) and calculates reliability of SLAM, and causes the transmission unit to transmit the signal when the reliability of SLAM is equal to or less than a predetermined value.

(4)

The information processing device according to (3), wherein

the determination unit

estimates the self-position by a combination of a first algorithm and a second algorithm, the first algorithm obtaining a relative position from a specific position by using a peripheral image showing the first user and an inertial measurement unit (IMU), the second algorithm identifying the absolute position in the real space by comparing a set of key frames provided in advance and holding feature points in the real space with the peripheral image.

(5)

The information processing device according to (4), wherein

the determination unit

corrects, in the second algorithm, the self-position upon recognition of any of the key frames by the first user, and matches a first coordinate system that is a coordinate system of the real space with a second coordinate system that is a coordinate system of the first user.

(6)

The information processing device according to any one of (1) to (5), wherein

the information about the self-position

includes a result of estimation of position and posture of the first user, estimated from the first user in the image, and

the correction unit

corrects the self-position based on the result of estimation of the position and posture of the first user.

(7)

The information processing device according to (4), wherein

the output control unit

controls output on the presentation device so as to guide the first user to an area in the real space where many key frames are positioned, after the self-position is corrected by the correction unit.

(8)

The information processing device according to any one of (1) to (7), wherein

the correction unit

when the determination unit determines a first state where determination by the determination unit completely fails before the self-position is corrected based on a result of estimation of position and posture of the first user, resets the determination unit to make the first state transition to a second state that is a state following at least the first state.

(9)

The information processing device according to any one of (1) to (8), wherein

the transmission unit

transmits the signal to a server device that provides the content,

the acquisition unit

acquires, from the server device receiving the signal, a wait action instruction instructing the first user to take predetermined wait action, and

the output control unit

controls output on the presentation device based on the wait action instruction.

(10)

The information processing device according to any one of (1) to (9), wherein the presentation device includes:

a display unit that displays the content; and

a speaker that outputs voice related to the content, and

the output control unit

controls display on the display unit and controls output of voice from the speaker.

(11)

The information processing device according to any one of (1) to (10), further comprising

a sensor unit that includes at least a camera, a gyro sensor, and an acceleration sensor,

wherein the determination unit

estimates the self-position based on a detection result from the sensor unit.

(12)

The information processing device according to any one of (1) to (11)

being a head-mounted display worn by the first user or a smartphone owned by the first user.

(13)

An information processing device providing content associated with an absolute position in a real space to a first user and a second user other than the first user, the information processing device comprising:

an instruction unit that instructs each of the first user and the second user to take predetermined action, when a signal requesting rescue on determination of a self-position is received from the first user; and

an estimation unit that estimates a position and posture of the first user based on information about the first user transmitted from the second user in response to an instruction from the instruction unit, and transmits a result of the estimation to the first user.

(14)

The information processing device according to (13), wherein

the instruction unit

instructs the first user to take predetermined wait action and instructs the second user to take predetermined help/support action, when the signal is received.

(15)

The information processing device according to (14), wherein

the instruction unit

instructs the first user to look to at least the second user as the wait action, and instructs the second user to look to at least the first user and capture an image including the first user as the help/support action.

(16)

The information processing device according to (15), wherein

the estimation unit

after identifying the first user based on the image, estimates the position and posture of the first user viewed from the second user based on the image, and estimates the position and posture of the first user in a first coordinate system that is a coordinate system of the real space, based on the position and posture of the first user viewed from the second user and a position and posture of the second user in the first coordinate system.

(17)

The information processing device according to (14), (15) or (16), wherein

the estimation unit

uses a bone estimation algorithm to estimate the posture of the first user.

(18)

The information processing device according to (17), wherein

the instruction unit

when the estimation unit uses the bone estimation algorithm, instructs the first user to step in place, as the wait action.

(19)

An information processing method comprising:

controlling output on a presentation device to present content associated with an absolute position in a real space, to a first user;

determining a self-position in the real space;

transmitting a signal requesting rescue to a device positioned in the real space, when reliability of determination in the determining is reduced;

acquiring information about the self-position estimated from an image including the first user captured by the device according to the signal; and

correcting the self-position based on the information about the self-position acquired in the acquiring.

(20)

An information processing method using an information processing device, the information processing device providing content associated with an absolute position in a real space to a first user and a second user other than the first user, the method comprising:

instructing each of the first user and the second user to take predetermined action, when a signal requesting rescue on determination of a self-position is received from the first user; and

estimating a position and posture of the first user based on information about the first user transmitted from the second user in response to an instruction in the instructing, and transmitting a result of the estimating to the first user.

(21)

An information processing device comprising:

an acquisition unit that acquires sensing data including an image obtained by capturing a user using a first presentation device presenting content in a predetermined three-dimensional coordinate system, from a sensor provided in a second presentation device different from the first presentation device;

a first estimation unit that estimates first position information about the user based on a state of the user indicated by the sensing data;

a second estimation unit that estimates second position information about the second presentation device based on the sensing data; and

a transmission unit that transmits the first position information and the second position information to the first presentation device.

(22)

The information processing device according to (21), further comprising

an output control unit that presents the content based on the first position information and the second position information,

wherein the output control unit

presents the content so that coordinate systems are mutually shared between the first presentation device and the second presentation device, based on a difference between a first trajectory that is a trajectory of the user based on the first position information and a second trajectory that is a trajectory of the user based on the second position information.

(23)

The information processing device according to (22), wherein

the output control unit

causes the coordinate systems to be mutually shared, when a difference between the first trajectory and the second trajectory extracted from substantially the same time slot is below a predetermined determination threshold.

(24)

The information processing device according to (23), wherein

the output control unit

causes the coordinate systems to be mutually shared based on a transformation matrix generated by comparing the first trajectory with the second trajectory by using an iterative closest point (ICP).

(25)

The information processing device according to (24), in which

the transmission unit

transmits the first position information and the second position information to the first presentation device via a server device; and

the server device

performs trajectory comparison process of generating the transformation matrix by comparing the first trajectory with the second trajectory.

(26)

An information processing method comprising:

acquiring sensing data including an image obtained by capturing a user using a first presentation device presenting content in a predetermined three-dimensional coordinate system, from a sensor provided in a second presentation device different from the first presentation device;

estimating first position information about the user based on a state of the user indicated by the sensing data;

estimating second position information about the second presentation device based on the sensing data; and

transmitting the first position information and the second position information to the first presentation device.

(27)

A computer-readable recording medium recording a program for causing

a computer to implement a process including:

controlling output on a presentation device so as to present content associated with an absolute position in a real space, to a first user;

determining a self-position in the real space;

transmitting a signal requesting rescue to a device positioned in the real space, when reliability in the determining is reduced;

acquiring information about the self-position estimated from an image including the first user captured by the device, according to the signal; and

correcting the self-position based on the information about the self-position acquired in the acquiring.

(28)

A computer-readable recording medium recording a program for causing

a computer to implement a process including:

providing content associated with an absolute position in a real space to a first user and a second user other than the first user;

instructing each of the first user and the second user to take predetermined action, when a signal requesting rescue on determination of a self-position is received from the first user; and

estimating a position and posture of the first user based on information about the first user transmitted from the second user in response to an instruction in the instructing, and transmitting a result of the estimating to the first user.

(29)

A computer-readable recording medium recording a program for causing

a computer to implement a process including:

acquiring sensing data including an image obtained by capturing a user using a first presentation device presenting content in a predetermined three-dimensional coordinate system, from a sensor provided in a second presentation device different from the first presentation device;

estimating first position information about the user based on a state of the user indicated by the sensing data;

estimating second position information about the second presentation device based on the sensing data; and

transmitting the first position information and the second position information to the first presentation device.

### REFERENCE SIGNS LIST

1, 1A INFORMATION PROCESSING SYSTEM
10 SERVER DEVICE
11 COMMUNICATION UNIT
12 STORAGE UNIT
13 CONTROL UNIT
13a ACQUISITION UNIT
13b INSTRUCTION UNIT
13c IDENTIFICATION UNIT
13d ESTIMATION UNIT
20 SERVER DEVICE
21 COMMUNICATION UNIT
22 STORAGE UNIT
23 CONTROL UNIT
23a RECEPTION UNIT
23b TRAJECTORY COMPARISON UNIT
23c TRANSMISSION UNIT
100 TERMINAL DEVICE
110 COMMUNICATION UNIT
120 SENSOR UNIT
140 DISPLAY UNIT
150 SPEAKER
160 STORAGE UNIT
170 CONTROL UNIT
171 DETERMINATION UNIT
172 TRANSMISSION UNIT
173 OUTPUT CONTROL UNIT
174 ACQUISITION UNIT
175 CORRECTION UNIT
200 TERMINAL DEVICE
210 COMMUNICATION UNIT
220 SENSOR UNIT
240 DISPLAY UNIT
250 SPEAKER
260 STORAGE UNIT
270 CONTROL UNIT
271 DETERMINATION UNIT
272 ACQUISITION UNIT
273 ESTIMATION UNIT
273a ANOTHER-PERSON'S BODY PART LOCALIZATION UNIT
273b ANOTHER-PERSON'S POSITION CALCULATION UNIT
273c SELF-LOCALIZATION UNIT
274 VIRTUAL OBJECT ARRANGEMENT UNIT
275 TRANSMISSION UNIT
276 RECEPTION UNIT
277 OUTPUT CONTROL UNIT
A, B, C, D, E, F, U USER
L LOCAL COORDINATE SYSTEM
W WORLD COORDINATE SYSTEM

1. An information processing device comprising:
an output control unit that controls output on a presentation device so as to present content associated with an absolute position in a real space, to a first user;
a determination unit that determines a self-position in the real space;
a transmission unit that transmits a signal requesting rescue to a device positioned in the real space, when reliability of determination by the determination unit is reduced;
an acquisition unit that acquires information about the self-position estimated from an image including the first user captured by the device according to the signal; and
a correction unit that corrects the self-position based on the information about the self-position acquired by the acquisition unit.

2. The information processing device according to claim 1, wherein
the device is another information processing device that is held by a second user to whom the content is provided together with the first user, and
a presentation device of the another information processing device
is controlled in output so as to guide at least the second user to look to the first user, based on the signal.

3. The information processing device according to claim 1, wherein
the determination unit
estimates the self-position by using simultaneous localization and mapping (SLAM) and calculates reliability of SLAM, and causes the transmission unit to transmit the signal when the reliability of SLAM is equal to or less than a predetermined value.

4. The information processing device according to claim 3, wherein
the determination unit
estimates the self-position by a combination of a first algorithm and a second algorithm, the first algorithm obtaining a relative position from a specific position by using a peripheral image showing the first user and an inertial measurement unit (IMU), the second algorithm identifying the absolute position in the real space by comparing a set of key frames provided in advance and holding feature points in the real space with the peripheral image.

5. The information processing device according to claim 4, wherein
the determination unit
corrects, in the second algorithm, the self-position upon recognition of any of the key frames by the first user, and matches a first coordinate system that is a coordinate system of the real space with a second coordinate system that is a coordinate system of the first user.

6. The information processing device according to claim 1, wherein
the information about the self-position
includes a result of estimation of position and posture of the first user, estimated from the first user in the image, and
the correction unit
corrects the self-position based on the result of estimation of the position and posture of the first user.

7. The information processing device according to claim 4, wherein
the output control unit
controls output on the presentation device so as to guide the first user to an area in the real space where many key frames are positioned, after the self-position is corrected by the correction unit.

8. The information processing device according to claim 1, wherein
the correction unit
when the determination unit determines a first state where determination by the determination unit completely fails before the self-position is corrected based on a result of estimation of position and posture of the first user, resets the determination unit to make the first state transition to a second state that is a state following at least the first state.

9. The information processing device according to claim 1, wherein
the transmission unit
transmits the signal to a server device that provides the content,
the acquisition unit
acquires, from the server device receiving the signal, a wait action instruction instructing the first user to take predetermined wait action, and
the output control unit
controls output on the presentation device based on the wait action instruction.

10. The information processing device according to claim 1, wherein
the presentation device includes:
a display unit that displays the content; and
a speaker that outputs voice related to the content, and
the output control unit
controls display on the display unit and controls output of voice from the speaker.

11. The information processing device according to claim 1, further comprising
a sensor unit that includes at least a camera, a gyro sensor, and an acceleration sensor,
wherein the determination unit
estimates the self-position based on a detection result from the sensor unit.

12. The information processing device according to claim 1
being a head-mounted display worn by the first user or a smartphone owned by the first user.

13. An information processing device providing content associated with an absolute position in a real space to a first user and a second user other than the first user, the information processing device comprising:
an instruction unit that instructs each of the first user and the second user to take predetermined action, when a signal requesting rescue on determination of a self-position is received from the first user; and
an estimation unit that estimates a position and posture of the first user based on information about the first user transmitted from the second user in response to an instruction from the instruction unit, and transmits a result of the estimation to the first user.

14. The information processing device according to claim 13, wherein
the instruction unit
instructs the first user to take predetermined wait action and instructs the second user to take predetermined help/support action, when the signal is received.

15. The information processing device according to claim 14, wherein
the instruction unit
instructs the first user to look to at least the second user as the wait action, and instructs the second user to look to at least the first user and capture an image including the first user as the help/support action.

16. The information processing device according to claim 15, wherein
the estimation unit
after identifying the first user based on the image, estimates the position and posture of the first user viewed from the second user based on the image, and estimates the position and posture of the first user in a first coordinate system that is a coordinate system of the real space, based on the position and posture of the first user viewed from the second user and a position and posture of the second user in the first coordinate system.

17. The information processing device according to claim 14, wherein
the estimation unit
uses a bone estimation algorithm to estimate the posture of the first user.

18. The information processing device according to claim 17, wherein
the instruction unit
when the estimation unit uses the bone estimation algorithm, instructs the first user to step in place, as the wait action.

19. An information processing method comprising:
controlling output on a presentation device to present content associated with an absolute position in a real space, to a first user;
determining a self-position in the real space;
transmitting a signal requesting rescue to a device positioned in the real space, when reliability of determination in the determining is reduced;
acquiring information about the self-position estimated from an image including the first user captured by the device according to the signal; and
correcting the self-position based on the information about the self-position acquired in the acquiring.

20. An information processing method using an information processing device, the information processing device providing content associated with an absolute position in a real space to a first user and a second user other than the first user, the method comprising:
instructing each of the first user and the second user to take predetermined action, when a signal requesting rescue on determination of a self-position is received from the first user; and
estimating a position and posture of the first user based on information about the first user transmitted from the second user in response to an instruction in the instructing, and transmitting a result of the estimating to the first user.

21. An information processing device comprising:
an acquisition unit that acquires sensing data including an image obtained by capturing a user using a first presentation device presenting content in a predetermined three-dimensional coordinate system, from a sensor provided in a second presentation device different from the first presentation device;
a first estimation unit that estimates first position information about the user based on a state of the user indicated by the sensing data;
a second estimation unit that estimates second position information about the second presentation device based on the sensing data; and
a transmission unit that transmits the first position information and the second position information to the first presentation device.

22. The information processing device according to claim 21, further comprising
an output control unit that presents the content based on the first position information and the second position information,
wherein the output control unit
presents the content so that coordinate systems are mutually shared between the first presentation device and the second presentation device, based on a difference between a first trajectory that is a trajectory of the user based on the first position information and a second trajectory that is a trajectory of the user based on the second position information.

23. The information processing device according to claim 22, wherein
the output control unit
causes the coordinate systems to be mutually shared, when a difference between the first trajectory and the second trajectory extracted from substantially the same time slot is below a predetermined determination threshold.

24. The information processing device according to claim 23, wherein
the output control unit
causes the coordinate systems to be mutually shared based on a transformation matrix generated by comparing the first trajectory with the second trajectory by using an iterative closest point (ICP).

25. An information processing method comprising:
acquiring sensing data including an image obtained by capturing a user using a first presentation device presenting content in a predetermined three-dimensional coordinate system, from a sensor provided in a second presentation device different from the first presentation device;
estimating first position information about the user based on a state of the user indicated by the sensing data;
estimating second position information about the second presentation device based on the sensing data; and
transmitting the first position information and the second position information to the first presentation device.
